(19) United States
(12) Patent Application Publication
(10) Pub. No.: US 2026/0223813 A1
(43) Pub. Date: Aug. 6, 2026

(54) FOOD CONTAINER COMPATIBLE WITH AUTOMATIC FEEDING ASSEMBLY

(71) Applicant: Automated Pet Care Products, LLC d/b/a Whisker, Auburn Hills, MI (US)

(72) Inventors: Jacob Zuppke, Bloomfield Hills, MI (US); Brad Baxter, Bloomfield Hills, MI (US); Daniel Ronge, Munich (DE); Mark Zeh, Munich (DE); Jason Weihman, Troy, MI (US); Garrison Hefter, Clawson, MI (US); Jason Smith, West Bloomfield, MI (US)

(21) Appl. No.: 18/865,478

(22) PCT Filed: May 15, 2023
(86) PCT No.: PCT/US2023/066998

§ 371 Date: Nov. 13, 2024

Related U.S. Application Data
(60) Provisional application No. 63/341,962, filed on May 13, 2022.

(51) Int. Cl. A01K 5/01; A01K 5/02

(52) U.S. Cl. CPC A01K 5/0121; A01K 5/0287

(57) ABSTRACT

A container suitable for storing a food for an animal therein, the container comprising: a) a container base defining a food cavity, wherein the container base includes: i) one or more flanges which include and/or form one or more keying features; b) a lid removably affixed to the container base, wherein the lid includes one of the following: i) a handling portion which includes a bottom surface of the lid which is exposed from the one or more; ii) the handling portion which extends beyond the container base such that a bottom of the lid is exposed and includes a reinforcement structure affixed thereto; or iii) the handling portion which extends away from the container base together with a reinforcing feature of the one or more flanges which is affixed thereto, and is configured for being engaged for peeling the lid from the container base.

### CROSS-REFERENCE TO RELATED APPLICATIONS

This application claims priority from U.S. Provisional Application Nos. 63/341,962, filed on May 13, 2022, and which is incorporated herein by reference in its entirety for all purposes.

### FIELD

The present disclosure relates to a container with a removable lid which is useful for containing food. The present disclosure may find particular use in providing a container which is compatible with an automatic feeding assembly for opening of the container to present the food displayed therein for subsequent consumption.

### BACKGROUND

Automatic pet food feeders on the market today are typically compatible with dry food, also commonly referred to as kibble. There are some automatic pet food feeders on the market compatible with wet food, but not the packaging of wet food. For example, some automatic feeders include separate compartments formed therein. The pet owner dispenses wet food from individual containers or pouches into the compartments. The feeder then exposes one compartment at a time based on a timer for the animal to have access to the food in the compartment. These feeders, while automatic, still present the problems including the pet owner needing to open the packaging and dispense the food; the food once placed into the feeder is not sealed against spoilage; due to spoilage, the feeder is only available to be left out and feed an animal for a limited duration of time; and the need for frequent cleaning of the feeder due to the wet food being located directly in the serving compartments.

In developing an automatic feeder able to cooperate with containers having peelable lids, store a plurality of containers therein, automatically open a container via peeling a lid away, and present the container to an animal for consumption of the food directly therefrom, a number of challenges were found with existing containers and their plastic or foil lids.

One common problem found with containers having lids removable by peeling, is that often the lid does not completely peel away, and remnants of the lid remain adhered to the rim of the container base. While in manual lid removal by a user this may simply be an annoyance that can be resolved by manually removing the remnants, this can render functionality of an automatic feeder ineffective. Depending on the amount of material of the lid left attached to the container base, an animal may simply be annoyed at the leftover lid material blocking the path to their food in the container or may even be completely blocked from gaining access to the food. Thus, what is needed is a container having a lid which can be cleanly peeled off without leaving remnants of the lid attached to the container base.

Another problem found in the development of an automatic feeder is the amount of wet food that can splatter during the internal automatic food delivery process within the feeder. Wet food for animals can be particularly odorous and create undesirably strong smells once spoiled. The amount of force required with a typical container to overcome the bond between a lid and container base to then peel the lid off the container base is prone to generating food splatter during lid removal. Thus, what is needed is a container which can reduce the amount of initial and/or end peeling force (e.g., initiating detaching at the leading edge and/or finishing detaching at the trailing edge) to remove a lid and to help reduce splatter.

One further challenge in providing a container compatible with an automatic feeder is providing a container which both stores the food therein (e.g., shipping, home storage, within a feeder) and is attractive to a pet to consume directly therefrom. While many single serving, disposable containers exist today, pet owners often find themselves transferring the food from the container into a serving dish. Pets, and most often cats, prefer not eating out of certain shapes or types of feeding containers. For example, containers having sharp corners in the interior limiting access to food, small container opening diameters preventing comfortable access by an animal's tongue, and sharp rims of a metal can or plastic base which can be felt on an animal's face. Thus, what is needed is a container that is not only compatible with a feeding assembly but also attractive and comfortable for an animal to consume food directly therefrom.

### SUMMARY

The present disclosure relates to a container suitable for storing a food for an animal therein, the container comprising: a) a container base defining a food cavity configured to retain food therein; b) a lid removably affixed to the container base, wherein the lid includes: i) a handling portion which extends beyond the container base and is configured for being engaged by a container opening structure for peeling the lid from the container base.

The present disclosure relates to a container suitable for storing a food for an animal therein, the container comprising: a) a container base defining a food cavity configured to retain food therein, wherein the container base includes: i) one or more flanges which include and/or form one or more keying features configured to provide for one or more orientations of the container; b) a lid removably affixed to the container base, wherein the lid is configured for being engaged by a container opening structure (e.g., subassembly) for peeling the lid from the container, wherein the lid includes one of the following: i) a handling portion which includes a bottom surface of the lid which is exposed from the one or more flanges and/or one or more rims of the container base; ii) the handling portion which extends beyond the container base such that a bottom of the lid is exposed (e.g., from the one or more flanges) and includes a reinforcement structure affixed thereto; or iii) the handling portion which extends away from the container base together with a reinforcing feature of the one or more flanges which is affixed thereto, and is configured for being engaged by a container opening structure (e.g., subassembly) for peeling the lid from the container base.

The present disclosure relates to a container suitable for storing a food for an animal therein, the container comprising: a) a container base defining a food cavity configured to retain food therein, wherein the container base includes: i) one or more flanges which include and/or form one or more keying features configured to provide for one or more orientations of the container; b) a lid removably affixed to the container base, wherein the lid is configured for being engaged by a container opening structure (e.g., subassembly) for peeling the lid from the container, wherein the lid includes one of the following: i) a handling portion which includes a bottom surface of the lid which is exposed from the one or more flanges and/or one or more rims of the container base; ii) the handling portion which extends beyond the container base such that a bottom of the lid is exposed (e.g., from the one or more flanges) and includes a reinforcement structure affixed thereto; or iii) the handling portion which extends away from the container base together with a reinforcing feature of the one or more flanges which is affixed thereto, and is configured for being engaged by a container opening structure (e.g., subassembly) for peeling the lid from the container base; c) one or more seal members which removably affix the lid to the container base, wherein the one or more seal members include: i) two or more opposing stress rise features formed as a portion of the seal member which to a concentrated and/or tapered point at the leading edge and the trailing edge.

The present disclosure relates to a container suitable for storing a food for an animal therein, the container comprising: a) a container base defining a food cavity configured to retain food therein, wherein the container base includes: i) one or more flanges which include and/or form one or more keying features configured to provide for one or more orientations of the container within a feeding assembly, a cartridge magazine, or both; ii) one or more lid reinforcing features affixed to a lid and configured to be removably attached to a remainder of the one or more flanges, a rim, or both; b) the lid removably affixed to the container base, wherein the lid is configured for being engaged by a container opening structure (e.g., subassembly) for peeling the lid from the container, wherein the lid includes one of the following: i) a handling portion which extends away from the container base together with a lid reinforcing feature of the one or more flanges which is affixed thereto, and is configured for being engaged by a container opening structure (e.g., subassembly) for peeling the lid from the container base; c) one or more seal members including: i) a first seal member which removably affixes the lid to the container base, wherein the first seal member is located between the rim and/or the one or more flanges of the container base and the lid, and is located about an opening of the food cavity, wherein the first seal member includes: two or more opposing stress rise features formed as a portion of the seal member which to a concentrated and/or tapered point at the leading edge and the trailing edge; and d) a second seal member which affixes the lid reinforcing feature of the one or more flanges to the handling portion of the lid such that the lid reinforcing feature remains adhered to the lid as the lid is peeled away from the container base.

The present teachings provide for a container suitable for use with an automatic feeder assembly. The container may be suitable for having wet food stored and sealed therein. The container may include a removable lid. The lid may be configured to interact with the feeding assembly for peeling. The container may include a handling portion configured to cooperate with a container opening subassembly. The handling portion may provide for consistent placement of the lid relative to the container opening subassembly. The container may include a lid reinforcing feature or structure. The lid reinforcing feature may aid in receiving a peeling force and distributing the peeling force. The container may include one or more seal members. A seal member may have stress rise features. Stress rise features may come to one or more concentrated and/or tapered points near a leading edge and/or trailing edge of the lid. Stress rise features may aid in directing the peeling force, requiring less peeling force than without their presence, or both. Stress rise features may aid in reducing and/or eliminating the likelihood of lid remnants remaining adhered to a container base, reducing splatter during initial opening and/or finishing peeling, or any combination thereof. The container may be relatively shallowed with rounded edges such as to provide a comfortable eating experience for an animal.

### BRIEF DESCRIPTION OF DRAWINGS

FIG. 1 is a perspective view of a container in a closed configuration.

FIG. 2 is a perspective view of a container in an open configuration.

FIG. 3 is a perspective view of a container in a closed configuration.

FIG. 4 is a perspective view of a container in an open configuration.

FIG. 5 is a left side view of a container.

FIG. 6 is a top view of a container in a closed configuration.

FIG. 7 is a top view of a container in an open configuration.

FIG. 8 is a perspective view of containers.

FIG. 9 is a perspective view of a container base.

FIG. 10 is a transparent top view of a container in a closed configuration.

FIG. 11 is a left side view of a container.

FIG. 12 is a perspective view of a feeding assembly.

FIG. 13 is a perspective view of a container being inserted into a feeding assembly.

FIG. 14 is a perspective view of a container being inserted into a feeding assembly.

FIG. 15 is a cross-section view of a container being inserted into a feeding assembly.

FIG. 16 is a cross-section view of a feeding assembly in a loading position.

FIG. 17 is a cross-section view of a feeding assembly in a loading position.

FIG. 18 is a cross-section view of a feeding assembly in an opening position.

FIG. 19 is a cross-section view of a feeding assembly in a feeding position.

FIG. 20 is a cross-section view of a feeding assembly in a disposing position.

FIG. 21 is a cross-section view of a feeding assembly in a resting position.

FIG. 22 is a perspective view of a container opening subassembly.

FIG. 23 is a cross-section view of a container opening subassembly with an open pinch gap (e.g., open jaws).

FIG. 24 is a cross-section view of a container opening subassembly with a closed pinch gap (e.g., closed jaws).

FIG. 25 is a side view of a container opening subassembly.

FIG. 26 is a perspective view of a container opening subassembly.

FIG. 27 is a front view of a container magazine.

FIG. 28 is a front view of a container magazine.

FIG. 29 is a front view of a container magazine.

### DETAILED DESCRIPTION

The explanations and illustrations presented herein are intended to acquaint others skilled in the art with the present teachings, its principles, and its practical application. The specific embodiments of the present teachings as set forth are not intended as being exhaustive or limiting of the present teachings. The scope of the present teachings should be determined with reference to the appended claims, along with the full scope of equivalents to which such claims are entitled. The disclosures of all articles and references, including patent applications and publications, are incorporated by reference for all purposes. Other combinations are also possible as will be gleaned from the following claims, which are also hereby incorporated by reference into this written description.

### Container

The present teachings relate to a container. The container may function for storing food therein, being used as a serving dish to have an animal consume therefrom, compatible with an automatic feeding assembly for automatically opening the container, compatible with an automatic feeding assembly for being presented to an animal to consume therefrom, or any combination thereof. The container may have the food sealed therein such as to extend the shelf life of the food and avoid the need for refrigeration.

Food may include any type of food suitable for consumption by an animal. Food may include wet food, dry food, or both. Wet food may include ground and/or shredded protein (e.g., meat), vegetables, grains, fruits, and/or the liked served in or mixed with a liquid. A liquid may refer to water, broth, gravy, or other liquid. Dry food may refer to food substantially free of liquid, may be in the form of granular material, or both.

The container may include a container base, a lid, a seal member(s), identifier(s), the like, or a combination thereof.

The container may include a lid which is removably coupled to the container base. The container base may define a hollow cavity (e.g., food cavity) for containing the food.

The container may have a symmetric or asymmetric shape. Symmetry may be about an axis or plane intersecting both a container base and lid.

A container may include one or more locating features (e.g., keying features, alignment features, engagement features). One or more locating features may allow for a container to be placed in a correct orientation within the feeding assembly. One or more locating features may include a plurality of locating features. A plurality of locating features may allow for a single correct orientation or a plurality of correct orientations within the feeding assembly. Features in the containers may appear twice or more in the containers to provide for two or more “correct” orientations of the containers within a container storage assembly. Features in the containers may appear only once or in a specific pattern to provide for only a single “correct” orientation of the container within a container storage assembly.

A container may have an open configuration, closed configuration, partially open configuration, the like, or any combination thereof.

A closed configuration may allow for shipping and storage of the container. Shipping may refer to movement of the container from a production facility to a point of retail, user, within a user's residence, and/or the like. Storage may refer to the storing at any time between production and use, including within a feeding assembly itself. A closed configuration may mean that a lid of the container is located and sealed to the container base. In a closed configuration, a lid may cooperate with a cavity base to completely seal a cavity of the cavity base. In a closed configuration, a lid may be adhered to or otherwise affixed to a flange and/or rim of a container base. In a closed configuration, a seal member may seal a lid to the container base. In a closed configuration, a lid may be affixed to a rim and/or flange via a seal member. It may be feasible to place a container into a closed configuration even after being in the open configuration. In other words, it may be possible to reseal a container base with the same lid that originally sealed the container, even after the container is opened.

An open configuration and/or partially open configuration may allow for access to food within a container, consumption of food directly from the container (e.g., by an animal), accessing food for placing into a serving dish, or any combination thereof. An open configuration may mean that a lid of the container is removed from a container base such as to expose the cavity thereof. By exposing the cavity, the food stored therein may be accessible. An open configuration may mean that a lid and/or seal member is detached or otherwise separated from a container base. A portion or all of the seal member may remain on the container base, the lid, or both when a lid is removed from a container base. An open configuration may mean that a casing is at least partially opened such as to expose the food stored therein. The food may then be removed from the casing or the casing removable from the food. An open configuration may mean that an entire cavity of the container base is exposed. A partially open configuration may mean that only a portion of the cavity of the container base is exposed. In the open configuration, the lid may be completely detached from the container base or remain partially attached. Being detached may allow for the lid to be disposed of separately from the container base. Remaining partially attached may allow for a lid to be reused to reseal the container base, be disposed of together with the container base, or both.

A container may cooperate with a feeding assembly to be moved from a closed configuration to an open configuration and/or partially open configuration or vice versa.

A container may be moved from a closed configuration to an open configuration manually by a user or vice versa.

A container may include a container base. A container base may function to retain food therein. A container base may function as a serving dish for an animal to consume directly therefrom. A container base may define an internal volume in which food may be placed. A food cavity may be defined by the internal volume. A container base may include one or more storage portions, rims, flanges, keying features, alignment features, engagement features, lid access features, lid reinforcing features, the like, or a combination thereof.

The container base may include a storage portion. A storage portion may define a hollow cavity for containing the food. A storage portion may be the portion of a container an animal consumes from. A storage portion may define a volume of food able to be stored within the container base. A storage portion may include one or more bottom walls, side walls, food cavities, the like, or any combination thereof.

A bottom wall may define the bottom surface of the container. The bottom wall may cooperate with the lid and one or more side walls to seal food stored within the container. The bottom wall may cooperate with one or more side walls to define a food cavity. The bottom wall may have one or more features for adding strength to the container, stacking with other containers, providing stability when resting on a surface, allowing for easy removal from a stack, the like, or any combination thereof.

A bottom wall may have a punt formed therein. A punt may define a concave and/or indented portion of the bottom wall. A punt may be an indentation upward, toward an opening defined by a rim, toward a lid, or any combination thereof. The punt may also allow for the bottom wall of the container to provide a space for one or more labels, identifiers, or other information to be located therein or on.

A bottom wall may have a cross-sectional shape (cut plane parallel to longitudinal and/or horizontal plane) or overall two-dimensional plan shape (viewing top down or bottom up) which is substantially circular, ovular, egg-shaped, teardrop-shaped, triangular, square, rectangular, polygonal (e.g., pentagon, hexagon), and/or the like. A bottom wall two-dimensional plan shape may be free of or include vertices. A bottom wall plan shape may be the same as or different than a cross-sectional shape or plan shape of the one or more side walls, food cavity, rim, flange, and/or lid. A bottom wall may have one or more side walls extending therefrom.

One or more side walls may define the outer surface of the container base. One or more side walls may determine part of, most of, or all of volume and/or height of a container and/or container base. One or more side walls may extend from the bottom wall. The one or more side walls may have a closed end and a free end. A closed end may be an end adjoining to a bottom wall. A free end may define the rim of the container base. One or more side walls may have or form a cross-sectional shape (cut plane parallel to longitudinal and/or horizontal plane) or overall two-dimensional plan shape (viewing top down or bottom up) which is substantially circular, ovular, egg-shaped, teardrop shaped, triangular, square, rectangular, polygonal (e.g., pentagon, hexagon), and/or the like. A two-dimensional plan shape of the one or more side walls may be the same as or different than a cross-sectional shape or plan shape of the bottom wall, food cavity, rim, flange, and/or lid. A two-dimensional plan shape of the one or more side walls may be free of or include vertices. Being free of any vertices may aid in an animal being able to access all food within the container and no or minimal food getting stuck in corners. Vertices may provide an overall shape which is easier to package, provide more storage volume, and/or the like. A rounded shape free of vertices may provide for a single side wall, while a shape with two or more vertices may provide for three or more side walls. Vertices in a container base may be provided as rounded corners to alleviate problems with food access.

One or more side walls may extend from a bottom surface at an angle which is substantially perpendicular, obtuse, or both. The angle may be the angle between a bottom surface and a side wall measured within a food cavity. The angle may be about 90 degrees or greater, about 95 degrees or greater, about 100 degrees or greater. The angle may be about 150 degrees or less, about 140 degrees or less, about 130 degrees or less, or even about 120 degrees or less. The angle may be about 95 degrees to about 120 degrees. The one or more side walls may define a narrower diameter or width of a food cavity toward the base as compared as toward the rim. This widening toward the opening may facilitate access of an animal to the food within the food cavity.

A container base may have a radius of curvature where a bottom wall transitions to a side wall. A curved transition may make it easier for an animal to access and consume all of the food in the food cavity by eliminating sharp edges and corners. A radius of curvature may refer to a radius measured at the interior of the container base (e.g., from within the food cavity) and/or from an exterior of the container base. The radius of curvature between the inside and exterior may be the same or different. The radius of curvature may be about 1.5 mm or greater, about 3 mm or greater, about 5 mm or greater, or even about 7 mm or greater. The radius of curvature may be about 20 mm or less, about 15 mm or less, about 12.5 mm or less, or even about 10 mm or less.

A container base may have a radius of curvature such that a bottom wall is continuous with one or more side walls. One or more side walls may not be definable as separate from a bottom wall. In other words, the container base may have an overall shape which is concave, half-sphere, or the like (e.g., bowl-shaped).

A container base may be configured as relatively shallow. Shallowness may be determined by the height of one or more side walls wall (e.g., from the bottom wall to a rim), from the exterior of the bottom wall to a top of the container base (upper surface of rim, flange, and/or side wall). Shallowness may allow for an animal to easily access food at the bottom of the container. The height of a container base may be about 1 cm or greater, 2 cm or greater, 3 cm or greater, or even 4 cm or greater. The height of a container base may be about 10 cm or less, about 8 cm or less, or even about 6 cm or less.

A container base may be configured to retain a volume of food. The volume may be about 20 mL or greater, about 30 mL or greater, or even about 50 mL or greater. The volume may be about 100 mL or less, about 80 mL or less, or even 70 mL or less.

A container base may include one or more rims. One or more rims may serve as the outer edge of a container base, one or more flanges, or both. One or more rims may include or be separate from one or more flanges. One or more rims may be located opposite a bottom wall, be a free end of a side wall, or both. One or more rims may be in direct contact, adhered to, or both a lid (e.g., when the container is in a closed configuration). One or more rims may have or form a cross-sectional shape (cut plane parallel to longitudinal and/or horizontal plane) or overall two-dimensional plan shape (viewing top down or bottom up) which is substantially circular, ovular, egg-shaped, teardrop shaped, triangular, square, rectangular, polygonal (e.g., pentagon, hexagon), lobe-shaped, and/or the like. A two-dimensional plan shape of the one or more rims may be the same as or different than a cross-sectional shape or plan shape of the bottom wall, one or more side walls, food cavity, one or more flanges, and/or lid.

A rim may have a generally planar surface, non-planar surface, or both. A rim may define an edge of one or more side walls. A rim may extend outward, inward, upward, downward, or any combination thereof relative to one or more side walls. A rim may extend laterally outward and/or generally orthogonally from one or more side walls. Laterally outward may be generally perpendicular to a vertical axis, parallel to a transverse plane, parallel to a flange plane, parallel to a horizontal plane, or any combination thereof. A portion of the rim which may extend outward form a top edge of a side wall may be defined as a top surface and/or lateral portion of a rim. A rim may extend downward. A downward extending portion may be defined as a downward projecting portion of the rim. A rim may project generally outward (e.g., away from a side wall, vertical axis) and then project generally downward (e.g., generally parallel to side wall, vertical axis). A rim may or may not define one or more flanges. One or more flanges may be defined as the portion of a rim which projects laterally outward from a sidewall, a portion of a container base which projects laterally away from a generally downward extending portion of a rim, or both.

A container base may include one or more flanges. One or more flanges may function to provide a surface for a lid to be adhered to, cooperate with one or more container storage subassemblies, cooperate with one or more container handling subassemblies, cooperate with a container magazine, the like, or any combination thereof. A flange may extend from a storage portion. A flange may extend from one or more side walls, one or more rims, or both. A flange may extend from and/or define the rim of the container base. A flange may be separate from, affixed to, and/or integral with the rim of the container base. A flange may be a laterally outward extending portion of a rim. A flange may extend substantially laterally from a side wall below a rim, from a downward projecting portion from a rim, below a top surface of a rim, or any combination thereof. In other words, flange may be located along any part of the height of one or more side walls and/or rim. A flange may be biased more toward the rim, an upper surface of a rim, and/or an upper surface of a side wall. A flange may provide a surface for handling a container, adhering to a lid, supporting a seal member, or any combination thereof. A flange may cooperate with one or more container storage subassemblies, container handling subassemblies, container opening subassemblies, container holding subassemblies, the like, or any combination thereof.

A flange may have a cross-sectional shape (cut plane parallel to flange, longitudinal and/or horizontal plane) or overall two-dimensional plan shape (viewing top down or bottom up) which is substantially circular, ovular, egg-shaped, teardrop shaped, triangular, square, rectangular, polygonal (e.g., pentagon, hexagon), lobe-shaped, and/or the like. A flange may have a shape which is asymmetrical or symmetrical about one or more planes. A flange may have a shape which is free of symmetry, includes one plane of symmetry, two or more planes of symmetry. A flange shape may aid in orienting of a container.

A flange and/or rim may have a width. A width of a flange and/or rim may provide sufficient surface area for affixing to a lid, cooperating with a seal member, cooperating with one or more components of a feeding assembly, the like, or any combination thereof. A width of a flange and/or rim may be measured substantially perpendicular to a vertical axis, from an edge facing toward the feeding cavity to an opposite edge facing toward an exterior, or both. The width of the flange and the rim may numerically and/or structurally be different or the same. For example, the rim may be the flange or the flange may be separate from the rim. If the same, they may share the same width. If different, they may have same or different widths. A width of the flange and/or rim may be about 2 mm or greater, about 3 mm or greater, about 3.5 mm or greater, about 3.8 mm or greater, about 4 mm or greater, about 4.5 mm or greater, or even about 4.7 mm or greater. A width of the flange and/or rim may be about 250 mm or less, about 225 mm or less, about 200 mm or less, about 180 mm or less, about 150 mm or less, about 125 mm or less, about 100 mm or less, about 75 mm or less, about 50 mm or less, about 25 mm or less, about 15 mm or less, about 12 mm or less, about 10 mm or less, about 7 mm or less, or even about 6 mm or less. The width of a rim and/or flange may be substantially uniform, vary, or both. For example, a width of a rim and/or flange may be substantially uniform about a majority of a periphery of a storage portion and/or container base, but vary in proximity to a lid access feature, lid reinforcing feature, leading edge of a lid, or a combination thereof.

A flange and/or rim may define one or more overall dimensions of a container base and/or container. The edge and/or outward facing surface of a flange and/or rim may define the outermost edges of the container and/or container base. A flange and/or rim may define a width and/or length of a container and/or container base. A width of a container and/or container base may be across a widest portion, perpendicular to a longitudinal plane, parallel to a transverse plane, or a combination thereof. A length of a container and/or container base may be across a longest portion, parallel to a longitudinal plane, perpendicular to a transverse plane, parallel to a frontal plane, measure from front (in proximity to leading edge) to rear (in proximity to trailing edge), or a combination thereof. A width of a container and/or container base may be about 75 mm or greater, about 85 mm or greater, about 90 mm or greater, or even about 95 mm or greater. A width of a container and/or container base may be about 130 mm or less, about 120 mm or less, about 110 mm or less, or even about 100 mm or less. A length of a container may be about 75 mm or greater, about 90 mm or greater, about 100 mm or greater, or even about 105 mm or greater. A length of a container may be about 150 mm or less, about 140 mm or less, about 130 mm or less, about 120 mm or less, or even about 115 mm or less.

A rim and/or flange may be substantially planar, non-planar, or both. A rim and/or flange may be substantially planar (e.g., upper surface, bottom surface) while having one or more non-planar features formed therein and/or affixed thereto. A rim (or an upper surface there of) may be substantially planar while a flange may be substantially planar, have non-planar features, or both. Non-planar features may include one or more keying features, engagement features, alignment features, lid access features, lid reinforcing features, and/or the like.

A flange may include one or more keying features, engagement features, alignment features, lid access features, lid reinforcing features, and/or the like.

A container may include or be free of one or more keying features. One or more keying features may function to allow for a container to be keyed for engagement with a feeding assembly, a container magazine, or both. One or more keying features may aid in a human correctly orientating a container, one more portions of a feeding assembly correctly orientating a container, or even one or more machines within an assembly process. One or more keying features may function to allow for a container to be keyed for engagement with a container storage subassembly, container magazine, container handling subassembly, container holding subassembly, waste collection subassembly, the like, or any combination thereof. One or more keying features may be formed in and/or affixed to any portion of a container which may be suitable. One or more keying features may be formed, included in, and/or affixed to one or more rims, flanges, side walls, bottom walls, lids, the like, or any combination thereof.

One or more keying features may be changes in contours in one or more portions of a container base. One or more keying features may include one or more concave portions, convex portions, protrusions, indentations, flat surface, straight edges, the like, or any combination thereof. One or more keying features may include an overall shape of flange, a two-dimensional shape of a flange, or both. For example, a flange may have a cross-sectional or plan shape which is not circular, does not have radial symmetry, or both. For example, shapes such as tear-drop, egg-shaped, circular with a lobe-shape, ovular with a blunt end, the like, or a combination thereof. Such a shape may aid in providing for limited correct orientations and aid in correct placement. Exemplary keying features may include one or more notches, tabs, rounded portions, and/or flat portions. Keying features may be formed in a flange such as to avoid impacting storage volume or shape of a storage portion of a container base. Keying features may be formed in a flange to aid in correct orientation of shapes which may have more than one plane of symmetry (e.g., square, rectangle, circle). One or more keying features may include one or more pockets formed in a flange.

One or more keying features may include a single keying feature or a plurality of keying features. Keying features may or may not be mirrored on an opposing portion of a container. Mirroring may provide for a single or two or more correct orientations of a container. For example, mirroring of keying features with a container base (e.g., flange) having only symmetry about one-plane, may provide for only a single correct orientation. For example, mirroring of keying features with a container base (e.g., flange) having symmetry about two or more planes, may provide for two or more correct orientation. A plurality of keying features may include 2 or more, 3 or more, 4 or more, or even 6 or more keying features. A plurality of keying features may all be the same or different from one another. One or more keying features may have the same and/or different shape and/or size one or more other keying features. For example, all of the keying features may be notches. As another example, some keying features may be notches while others are straight edges. As another example, a single keying feature may be the overall two-dimensional shape of a flange.

One or more keying features may include, function as, or be separate from one or more alignment features, engagement features, lid access features, lid reinforcing features, the like, or a combination thereof.

A container may include or be free of one or more alignment features. One or more alignment features may facilitate alignment of a container within a container storage subassembly, container magazine, container handling subassembly, or both. One or more alignment features may facilitate alignment of a container within a hopper, cartridge magazine, shuttle assembly, gripper assembly, lifting wedge, the like, or a combination thereof. One or more alignment features may facilitate maintaining a container oriented properly during movement within a feeding assembly, facilitate loading of a container, or both. One or more alignment features may prevent rotation, teetering, or turning of a container once loaded into a container storage subassembly, container magazine, container handling subassembly, or any combination thereof.

One or more alignment features may include a change in contour of a rim, flange, bottom wall, side wall(s), or any combination thereof. One or more alignment features may include one or more indentations, projections, planar surface, planar edges, rounded surfaces, rounded edges, or any combination thereof in a rim, flange, bottom wall, side wall, or combination thereof. One or more alignment features may include a change in contour in an upper surface, lower surface, and/or peripheral edge of a rim, flange, bottom wall, side wall, or combination thereof. One or more alignment features may include one or more protrusions extending from a rim and/or flange of the container base laterally way from the lid, generally parallel with a vertical axis, toward a bottom wall, or any combination thereof. One or more alignment features may be reciprocal in shape to or provide a reciprocal shape with one or more portions of a container storage subassembly, container magazine, container handling subassembly, or any combination thereof.

One or more alignment features may be located at one or more engagement points with one or more components of a feeding assembly. One or more alignment features may be biased toward the rear of a container, front of a container, a leading edge and/or a trailing edge, sides of a container, or any combination thereof. One or more alignment features may be fairly centered or off-center relative to a frontal plane, longitudinal plane, or both. One or more alignment features may or may not be mirrored relative to one or more other alignment features. One or more alignment features may be mirrored relative to one or more opposing alignment features. One or more alignment features may be located opposite one another relative to a frontal plane, longitudinal plane, or both.

One or more alignment features may cooperate with a cradle, one or more pairs of arms, or both. Cooperation may include engagement, mating, providing a friction surface, providing a channel, providing reciprocal surfaces, or any combination thereof. For example, one or more alignment features together with a side wall of a container and a bottom surface of a flange may form a channel (e.g., C-shape channel). For example, one or more alignment features may include two or more projections projecting from a side wall and forming a groove, and/or channel about at least a portion of the container base. For example, one or more alignment features may include one or more indentations or projections forming a groove or channel in a bottom wall. The channel and/or groove may receive a portion of a cradle, one or more arms, a support plate (e.g., of a handling subassembly) or combination thereof and aid in maintaining the container base in a stationary position relative thereto. For example, one or more alignment features may be a planar portion of a side wall which is mostly curved. The planar portion of the side wall may align with a planar portion of a container handling subassembly, container storage subassembly, or both.

A container may include or be free of one or more engagement features. One or more engagement features may function to engage with one or more components of a feeding assembly, container magazine, maintain proper orientation and retain of the container relative to the one or more components or both. One or more engagement features may cooperate with one or more container storage subassemblies, container magazines, container handling subassemblies, container holding subassemblies, or combination thereof. One or more engagement features may engage with a cradle, a pair of arms, a support plate (e.g., of a container handling subassembly), lifting wedge, or any combination thereof. One or more engagement features may be the same or separate from one or more keying features, alignment features, or both.

One or more engagement features may provide a shape which receives a portion of one or more container storage subassemblies, container handling subassemblies, container holding subassemblies, the like, or any combination thereof. One or more engagement features may be provided in a rim, flange, bottom wall, side wall, or any combination thereof. One or more engagement features may function to receive one or more projections partially or entirely therethrough. One or more engagement features may or may not be partially or completely reciprocal with one or more projections. One or more engagement features may include one or more holes, depressions, grooves, and/or the like.

One or more projections may include one or more pins, tabs, posts, hooks, and/or the like. One or more projections may be part of a container storage subassembly, container handling subassembly, container holding subassembly, and/or the like. One or more projections may extend from one from one or more cradles, arms, support plates (e.g., of a container handling subassembly), lifting wedges, rails, and/or any combination thereof. For example, one or more projections may include pins protruding from one or more arms of a container handling subassembly, a gripper plate and/or support plate of a container handling subassembly, a cradle of a container handling subassembly, a lifting ramp of a container holding subassembly, or any combination thereof.

Exemplary engagement features may include a plurality of holes defined at predetermined locations through a rim and/or flange of the container base. These holes may receive corresponding pins protruding from a gripper plate and/or cradle of the container handling subassembly. Together, the holes and pins may maintain proper orientation and retention of the container base within various stages of the feeding cycle.

A container base may include or be free of one or more lid access features. One or more lid access features may function to allow a portion of a lid to be accessible; allow a bottom surface of a lid to be accessible, in addition to an upper surface; expose a portion of a bottom of a lid; allow for a leading edge to be accessible; receive one or more components of a container opening subassembly; allow for one or more components of a container opening subassembly to engage with a lid for subsequent removal; or a combination thereof. One or more lid access features may protect a leading edge, trailing edge, or both of a lid. One or more lid access features may be provided in one or more locations of a container.

A container may be configured to have a single correct orientation or multiple correct orientations for being located into a feeding assembly and/or cooperating with a container opening subassembly. A lid may be formed such that the leading edge and trailing edge may or may not be reversible. For example, a container may have no planes of symmetry or just one plane of symmetry to provide for one correct orientation or two planes of symmetry to provide for two correction orientations. A container with a single correct orientation may have one or more lid access features only adjacent to and/or in proximity to a leading edge of a lid. A container with two correct orientations may have one or more lid access features adjacent to and/or in proximity to a leading edge and a trailing edge of a lid.

One or more lid access features may include one or more pockets, one more rim and/or flange indentations, one or more rim/or flange blunt surfaces, the like, or any combination thereof.

One or more lid access features may include one or more pockets. One or more pockets may function to protect and maintain a handling portion of a lid. One or more pockets may create a pocket gap for a portion of a container opening subassembly to be received in. A pocket may be defined by or coupled to a rim and/or flange of a container base. A pocket may extend below the upper surface of the container base, below a flange plane, below a flange axis, below the main upper surface of a flange, or any combination thereof. A pocket may be formed in a flange and/or rim of a container base. A pocket may be formed as an indentation, concave portion, and/or the like in a flange and/or rim. A pocket may project away from a lid, away from an upper surface of a container base, away from an upper surface of a rim and/or flange, toward a bottom of a container, generally parallel to a vertical axis of the container, or a combination thereof. A pocket may be formed in proximity to and/or adjacent to a leading edge of a lid, trailing edge of a lid, a stress rise feature of a seal member, or a combination thereof. A pocket may cooperate with a lid to define a pocket gap. A pocket gap may be a distance between the pocket and the lid.

One or more lid access features may include one or more rim indentations. One or more rim indentations may function to allow a bottom surface of a lid to be accessible, in addition to an upper surface; may allow for a leading edge to be accessible; may expose a portion of a lid relative to container; may allow for one or more components of a container opening subassembly to engage with a lid; or any combination thereof. One or more rim indentations may be formed in a rim and/or flange of a container base. One or more rim indentations may be formed in proximity to and/or adjacent to a leading edge of a lid, a stress rise feature of a seal member, or both. One or more rim indentations may project inward toward a vertical axis, a center of the container, a center of a rim and/or flange, or a combination thereof. One or more rim indentations may be formed as one or more cutouts and/or notches. One or more rim indentations may refer to a localized area of contour change of a rim and/or flange. One or more rim indentations may have a shape reciprocal with or dissimilar to one or more components of a container opening subassembly. One or more rim indentations may have a shape reciprocal or dissimilar to one or more jaws, hooks, and/or the like. One or more rim indentations may have a shape with a cross-sectional area equal to or larger than a cross-sectional area of one or more jaws, hooks, and/or the like. A cross-sectional area equal to or larger than a cross-sectional area of one or more jaws and/or hooks may allow for them to have sufficient access to a lid for removal.

One or more lid access features may include one or more blunt surfaces (e.g., straight edges). One or more blunt surfaces may function to allow a bottom surface of a lid to be accessible, in addition to an upper surface; may allow for a leading edge to be accessible; may expose a portion of a lid relative to container; may allow for one or more components of a container opening subassembly to engage with a lid; or any combination thereof. One or more blunt surfaces may be formed in a rim and/or flange of a container base. One or more blunt surfaces may be formed in proximity to and/or adjacent to a leading edge of a lid, a stress rise feature of a seal member, or both. One or more blunt surfaces may be formed as one or more straight edges, edges tangent to a majority of a contour, or both of one or more rims and/or flanges. One or more blunt surfaces may be formed as a substantially flat and/or straight edge of a rim and/or flange. One or more blunt surfaces may be dissimilar to the majority of peripheral contour of a rim and/or flange. One or more blunt surfaces may be formed in a cross-sectional and/or two-dimensional plan shape coming to a straight surface. For example, one or more rounded shapes may have one or more straight edges formed therein. For example, a circle, oval, egg-shape, tear-drop shape, and/or the like may curve and/or narrow to a straight edge to form a blunt surface. The blunt surface may be opposite a rounded surface. One or more blunt surfaces may refer to a localized area of contour change of a rim and/or flange. One or more blunt surfaces may also define an exposed area of the lid referred to as the handling portion.

A container may include or be free of one or more lid reinforcing features. One or more lid reinforcing features may function to reinforce a lid during removal from a container base, prevent tearing of the lid while peeling away from the container base, provide a structurally sufficient structure to cooperate with a container opening subassembly, or any combination thereof. One or more lid reinforcing features may function as one or more keying features, provide for consistent orientation of a lid, or both. Often, when peelable lids are peeled away from respective container bases, these lids tear, leaving remnants of the lid still adhered to the container base. The remnants may block access of an animal into the food cavity to consume food therein. This is especially problematic with an automatic feeding assembly, as a user may not be physically present to remove the remnants of the lid.

The lid reinforcing feature may aid in distributing the peeling force to the outer periphery, seal member, and/or away from a center line/longitudinal plane (e.g., while a lid is being peeled away from a container base). By distributing the peeling force outward, this reduces and/or eliminates the risk of the lid being incompletely peeled and leaving behind remnants of lid adhered to the container base. The peeling force may be distributed outward during an initial motion of peeling, when initiating peeling at a leading edge, before reaching a halfway point of peeling, before peeling reaches the widest portion of a container base, or any combination thereof. A lid reinforcing feature may also aid in reducing the amount of force required to initiate peeling. This may be compared to the force required in the absence of the lid reinforcing feature. This force reduction may aid in reducing and/or eliminating splatter from food contained within the container base.

The lid reinforcing feature may aid in distributing the peeling force toward a seal member, toward a center line and/or longitudinal plane, or both (e.g., while a lid is being peeled away from a container base). By distributing the peeling force inward, this reduces and/or eliminates the risk of the lid being completely peeled and leaving behind remnants of lid adhered to the container base. The peeling force may be distribution outward during a latter motion of peeling, when peeling starts to reach a trailing edge, after reaching a halfway point of peeling, after peeling reaches a widest portion of a container base, or any combination thereof. A lid reinforcing feature may also aid in reducing the amount of force required to finalize peeling. This may be compared to the force required in the absence of the lid reinforcing feature. This force reduction may aid in reducing and/or eliminating splatter from food contained within the container base.

One or more lid reinforcing features may be provided as part of the lid, the container base, or both. One or more lid reinforcing features may be provided at a handling portion of a lid. A handling portion may be located toward and/or adjacent to a leading edge of a lid, a portion of a lid and/or container base (e.g., flange) a container opening subassembly may interact with, or both. A handling portion may be located adjacent to one or more lid access features. A handling portion may be exposed by a lid access feature.

One or more lid reinforcing features may be formed as part of or separate from a flange and/or rim. The one or more lid reinforcing features may be a part of the rim and/or flange configured to be separated from the remainder of the rim and/or flange. This may be referred to as a removable flange portion and/or removable rim portion. For simplicity, the removable flange and removable rim portion may be referred to as a removable flange portion. A removable flange portion may be planar or non-planar with the remainder of the flange and/or rim. A removable flange portion may be formed as a raised portion of the flange, may be even with a rim or the flange, may be in contact and adhered to a lid, or any combination thereof. The removable flange portion may be formed as an extension of the flange. In other words, the removable flange portion may be an extension of the flange that provides a greater surface area than the remainder of the flange. The removable flange portion may or may not include any removal openings. A removal opening may be similar as disclosed to that of the lid. If present, a removal opening of the removable flange portion may be aligned with the removal opening of the lid.

The removable flange portion may include a vertically extending portion. A vertically extending portion may define a portion of the removable flange portion that bends upwards from a flange, toward a lid, toward a same height as a top surface of a rim, or any combination thereof. A vertically extending portion may allow for the removable flange portion to be formed as a raised portion. A vertically extending portion may have a height of about 1 mm or greater, about 2 mm or greater, about 3 mm or greater, or even about 4 mm or greater. A vertically extending portion may have a height of about 20 mm or less, about 15 mm or less, about 12 mm or less, about 10 mm or less, about 8 mm or less, or even about 6 mm or less. The vertically extending portion may provide for a transition between a flange (or majority thereof) and the removable flange portion.

The removable flange portion may include a lid contact portion. A lid contact portion may define a portion of the removable flange portion in direct contact with a lid, may be in direct contact with a handling portion of the lid, may interface with one or more container opening subassemblies, the like, or any combination thereof. A lid contact portion may be at the same or different plane as a flange, rim, or both. A lid contact portion may extend from a removable flange portion. A lid contact portion may define a portion of the flange and/or rim with a different contour than a remainder of a majority of the flange and/or rim. The removable flange portion may include a removal opening therein. The lid contact portion may form a leading edge of the flange and/or rim. The leading edge of the flange and/or rim may coincide with a leading edge of a lid. A lid contact portion may have a length. A length may be measured from a point of separation to a free end, from a separation feature to a free end, from an end closest to the container storage portion to an opposing end, from a vertically extending portion to an end of the lid contact portion, across one plane, across a plane generally parallel to the horizontal and/or transverse plane, generally parallel to a flange plane, or any combination thereof. A length may be about 2 mm or greater, about 5 mm or greater, about 7 mm or greater, or even about 10 mm or greater. A length may be about 50 mm or less, about 30 mm or less, about 25 mm or less, about 20 mm or less, or even about 15 mm or less.

It is also envisioned that a lid reinforcing feature may be separate from a flange and/or rim. In other words, the lid reinforcing feature may be affixed to a lid and not be affixed to a rim and/or flange. A lid reinforcing feature may include a lid contact portion. A lid reinforcing feature may be free of a vertically extending portion. A lid reinforcing feature may be located adjacent to or in proximity to a lid access feature. A lid reinforcing feature may be located adjacent to a blunt surface of a rim and/or flange. A lid reinforcing feature, even if separate from a rim and/or flange, may be comprised of the same material as the flange and/or rim (e.g., same material as the container base).

One or more lid reinforcing features of a flange may be removable by one or more separation features. A separation feature may allow for a removable flange portion to be affixed to and integral with the remainder of the flange while aiding in easy removal simultaneous with removing of a lid. A separation feature may include one or more weak spots, indentations, grooves, scoring lines, perforations, and/or the like. For example, a separation feature may include a scoring line between a removable flange portion and the remainder of the flange portion. A separation feature may be located adjacent to a vertically extending portion of a lid reinforcing feature and the remainder of the flange and/or rim. A container opening subassembly may engage with (e.g., grip, hook, etc.) the removable flange portion and the lid. As the container base and/or the lid is moved away from the lid and/or the container base, the separation feature may first receive a peeling force before a seal member. The peeling force may cause the separation feature to break and cause separation of the removable flange portion while still being adhered to the lid.

A container base may be comprised of one or more materials. One or more materials may include one or more polymers, metals, the like, or a combination thereof. One or more polymers may include one or more plastics. One or more plastics may be biodegradable, nonbiodegradable, or both. One or more materials may include one or more food-grade plastics. One or more plastics may include polyethylene terephthalate (PET), high-density polyethylene (HDPE), low-density polyethylene (LDPE), polyvinyl chloride (PVC), polypropylene (PP), polystyrene (PS), polycarbonate, ethylene vinyl alcohol (EVOH), the like, or a combination thereof.

The container may include a lid. A lid may function to close or seal a container, preserve food within a container, or both. A lid may be shaped to be reciprocal with, similar to, dissimilar to, fully cover a food cavity of a container base, or any combination thereof. A lid may be shaped to be reciprocal with, similar to, dissimilar to, fully cover, partially cover, or any combination thereof a flange and/or rim of a container base. The lid may be adhered to the container base. The lid may be partially or completely removable. Removing a lid may transition a container from a closed configuration to an open configuration.

An edge of the lid which is peeled or otherwise removed from the container first may be referred to as a leading edge. An edge of the lid which is peeled last, remains adhered, or otherwise removed may be referred to as a trailing edge. A peeling force may be applied from a leading edge toward and/or to the trailing edge.

A lid may be releasably coupled to the container base. A lid may be releasably attached to the rim and/or flange. A lid may be releasably coupled to a container base via a seal member. A lid may or may not be able to be recoupled to a container base.

A lid may be shaped such as to completely cover an opening of a container base defining a food cavity therein. A lid may be shaped to cover the opening defined by the rim and/or flange of a container base. A lid may be shaped such as to cooperate with a container opening subassembly. A lid may be shaped such as to allow for consistent presentation and locating relative to a container opening subassembly container magazine, or both. A lid may be shaped for repeatable and accessible gripping, clamping, hooking, and/or the like by a container opening subassembly, user, or both.

A lid may be shaped such that when a lid is presented to a container opening subassembly it is presented at a consistent location with a leading edge facing toward the container opening subassembly. A lid may have a cross-sectional shape (cut plane parallel to upper surface of lid, longitudinal and/or horizontal plane) or overall two-dimensional plan shape (viewing top down or bottom up) which is substantially circular, ovular, egg-shaped, teardrop shaped, triangular, square, rectangular, polygonal (e.g., pentagon, hexagon), lobe-shaped, and/or the like. A lid may have a shape which is asymmetrical or symmetrical about one or more planes. A lid may have a shape which is free of symmetry, includes one plane of symmetry, two or more planes of symmetry. A lip shape may aid in orienting of a container within one or more components of the feeding assembly.

A lid may include a handling portion. A handling portion may provide for a portion of the lid which is gripped, clamped, hooked, and/or otherwise retrieved to allow for a peeling force to be applied for removal of the lid. A handling portion may be a portion of the lid which extends beyond a container base, rim, and/or flange. A handling portion of the lid may be a portion of the lid intended for engagement with a container opening subassembly. A handling portion may extend beyond most of a flange but have a lid reinforcing feature affixed thereto. A handling portion may have a removable flange portion affixed thereto. A handling portion may have a lid contact portion affixed thereto. A handling portion may extend in the same direction as a flange, laterally project away from one or more side walls of a container base, or both. A handling portion of the lid may be formed as an extension tab. A handling portion may not be folded over a rim and/or flange, as is typically seen in standard single use food containers.

A lid may include a rigid engagement portion. A rigid engagement portion may be disposed on the handling portion of the lid. A rigid engagement portion may be the same or different as the lid reinforcing feature described relative to the flange. A rigid engagement portion may be the same as or different from the lid contact portion of a lid reinforcing feature. The rigid engagement portion may prevent the lid from collapsing or moving relative to the container base and/or a remainder of the lid. A rigid engagement portion may ensure that the lid projects away from the container base and the handling portion can be reliably engaged with by the container opening subassembly. A rigid engagement structure can project beyond an edge of a rim of the container base, may be part of the flange, may be separate from the flange, may be an extension of the flange, or any combination thereof.

A handling portion may have a length and/or shape the same as or similar as described suitable for a lid reinforcing feature.

The handling portion of the lid may or may not include any removal openings. A removal opening may cooperate with one or more container opening subassemblies. A removal opening may be configured to receive a portion of a container opening subassembly therein. A portion of the container opening subassembly may be any portion configured to grip, grasp, hook, or otherwise engage and retain the lid for subsequent removal from a container base. A removal opening may receive a hook, post, jaw, and/or the like. A removal opening may have a shape which is or is not reciprocal with a portion of the container opening subassembly. A removal opening may have a cross-sectional size (e.g., area) about equal or larger than a portion of the container opening subassembly. A larger size may facilitate insertion of a portion therein or through. A removal opening may be biased toward a leading edge. A removal opening may be located between a leading edge and a stress rise feature. If the handling portion cooperates with a lid removable flange portion, a removal opening of the handling portion may be aligned with the removal opening of the removable flange portion.

A lid may be comprised of one or more materials. One or more materials may include one or more polymers, metals, the like, or a combination thereof. One or more materials of the lid may be the same as or different as compared to the one or more materials of the container base. One or more polymers may include one or more plastics. One or more plastics may be biodegradable, nonbiodegradable, or both. One or more materials may include one or more food-grade plastics. One or more plastics may include polyethylene terephthalate (PET), high-density polyethylene (HDPE), low-density polyethylene (LDPE), polyvinyl chloride (PVC), polypropylene (PP), polystyrene (PS), polycarbonate, ethylene vinyl alcohol (EVOH), the like, or a combination thereof. One or more metals may include one or more food-safe metals. One or more food-safe metals may include aluminum, cooper, or the like. One or more metals may be formed as foil. For example, the lid may be comprised of aluminum foil. A lid may be formed as a laminate. For example, a PP-EVOH-PP laminate structure.

The container may include one or more seal members. One or more seal members may function to removably couple a lid to a container base, adhere a lid to a container base, permanently adhere a lid reinforcing feature to a lid, or any combination thereof. A seal member may refer to a means of directly adhering a lid to a container base, an adhesive separate from the lid and the container base, or both.

One or more seal members may include one or more weld joints, adhesives, and/or the like. One or more adhesives may include one or more pressure sensitive and/or hot melt glues. One or more adhesives may include polyvinyl acetate (PVA), vinyl acetate ethylene (VAE), vinyl acetate acrylates (VAA), ethylene-vinyl acetate (EVA), metallocene, polyurethane reactive material, the like, or any combination thereof. One or more weld joints may be created via one or more weld methods. One or more weld methods may include ultrasonic plastic welding, vibration welding, laser welding, spin welding, infrared welding, hot plate welding, heat staking, the like, or any combination thereof. One or more seal members may include one or more food-safe adhesives and/or joining methods.

A seal member may be located on a rim, flange, lid, or combination thereof. A seal member may be located about all or a portion of the rim and/or flange. In the case the flange extends from the rim, the seal member may be located on the upper surface of the flange. In the case the flange is located below the rim, the sealing member may be located on the rim. A seal member may also be located on one or more lid reinforcement features, such as a removable flange portion. A seal member may be located between a container base and a lid. A seal member may be located between a rim and/or flange and a lid. When a lid is removed (e.g., peeled) from a container base, a seal member may be fully detached from, partially detached from, and/or remain attached to the container base and/or the lid. A seal member may include a first seal member and a second seal member. A first seal member may function to removably adhere a lid to a container base. A first seal member may be located about the container storage portion. A first seal member may be located between a main rim and/or flange portion and the lid. A second seal member may function to permanently adhere a lid to a lid reinforcing feature. A second seal member may be located between a lid contact portion and the lid. A second seal member may be located an on opposite side of a of a separation feature (e.g., scoring line) as the first seal member.

A seal member may have a shape substantially reciprocal with one or more portions of a lid, container base, or both. A seal member may have a shape substantially reciprocal with cross-section of the storage portion (e.g., side wall, food cavity), a rim, and/or flange of a container base. For example, seal member may have a shape substantially reciprocal with a storage portion and/or rim of a container while having a shape dissimilar to that of flange of the container base. A seal member may have an overall two-dimensional plan shape (viewing top down or bottom up) which is substantially circular, ovular, egg-shaped, teardrop shaped, triangular, square, rectangular, polygonal (e.g., pentagon, hexagon), and/or the like. For example, if a container storage portion has a substantially circular plan shape or cross-section, the seal member may have a substantially circular plan shape or cross-section. A seal member may come to one or more concentrated points and/or tapered portions. A shape may be lemon-shaped, diamond-shaped, the like, or a combination thereof.

A seal member may include one or more stress rise features. One or more stress rise features may facilitate removal of a lid from a container base, may reduce splatter of food from within the container base to the outside, may require less force to initiate peeling of the lid off the container base at a leading edge (as compared to seal member without a stress rise feature), may require less force (as compared to a seal member without a stress rise feature) to complete peeling of the container at a trailing edge, the like, or a combination thereof. A seal coming to one or more concentrated and/or tapered points (e.g., vertices) may provide for one or more stress rise features. One or more stress rise features may include sharp edges (e.g., vertices) at axial ends of a seal member. Sharp edges (e.g., vertices) may be disposed at a location where peeling of the lid from the containers may be first start (e.g., leading edge) and/or end (e.g., trailing edge).

The container may include one or more tensioning features. One or more tensioning features may function to couple a lid to a container base. One or more tensioning features may be located at one or more predetermined locations. One or more tensioning features may be located on one or more outer edges of a lid. One or more tensioning features may be located where an outer edge of a lid is located atop a portion of a rim. One or more tensioning features may include one or more heat sealed dots, spot welds, adhesives, the like, or combination thereof. One or more tensioning features may be proximate to, adjacent to, on either side of, or a combination thereof one or more stress rise features. One or more tensioning features may be used in combination with a seal member and/or in lieu of a seal member.

The container may include one or more identifiers. The one or more identifiers may function to indicate one or more parameters associated with the container. One or more identifiers may include one or more visual identifiers, signal identifiers, or both. One or more visual identifiers may include one or more quick response (“QR”) codes, bar codes, colored pattern, textures, surface reflectivity patterns, the like, or a combination thereof. One or more signal identifiers may include one or more radio frequency identification tags (“RFID”), near-field communication (“NFC”) tags, the like, or any combination thereof. One or more RFID identifiers may be passive. The one or more identifiers may be disposed on one or more portions of the container. The one or more identifiers may be disposed on an exterior of the container. One or more identifiers may be located on an exterior of the lid, an exterior the one or more side walls of the container base, a bottom wall of a container base, an exterior of a casing, the like, or any combination thereof. The one or more identifiers may be placed on a container such as to be accessible and readable by an identification sensor. The one or more parameters associated with an identifier may include compatibility with the feeding assembly, a type of food in the container, a volume of food in the container, nutritional values associated with the food in the container, a brand or manufacturer of the food in the container, a production and/or packaging date of the food in the container, an amount of time food may be unsealed and exposed to ambient temperatures before beginning to spoil, an expiration date, the like, or any combination thereof. The one or more parameters associated with the identifier may include one or more instructions to access one or more databases to retrieve information about the container or food.

One or more portions of a container may define or be defined by one or more axes, planes, or both.

The one or more axes may include a vertical axis, horizontal axis, longitudinal axis, frontal axis, transverse axis, flange axis, the like, or any combination thereof. A vertical axis may extend through a container base and lid, through a bottom of a container base and cavity defined therein, through a bottom of a container base and an aperture defined by a rim and/or flange, or any combination thereof. A vertical axis may be generally perpendicular to the bottom of a container base, rim, flange, lid, or a combination thereof. A vertical axis may be generally parallel to a side wall of a container base. A frontal and/or center axis may be a vertical axis which is generally centered with the container, container base, lid, or combination thereof. A horizontal axis may be generally perpendicular to a vertical axis. A horizontal axis may be generally parallel with a rim, flange, lid, bottom of a container base, or combination thereof. A horizonal axis may intersect or be free of intersecting a vertical axis. A longitudinal axis may be a horizontal axis. A longitudinal axis may include a center line of the container. A transverse axis may be a horizontal axis. A flange axis may be an axis which is generally parallel with a majority of a surface area of a flange. A flange axis may be generally parallel or offset from a horizontal axis, longitudinal axis, or both.

The one or more planes may include a flange plane, rim plane, lid plane, longitudinal plane, transverse plane, frontal plane, the like, or a combination thereof. A flange plane may be a plane defined by a majority of a surface area (e.g., upper surface, surface facing toward lid) of a flange. A flange plane may have a flange axis lying therein (e.g., parallel, not intersecting). A flange plane may be substantially parallel to a transverse plane, a lid plane, or both. A rim plane may be a planed defined by a majority of a surface area of a rim. A rim plane may be parallel to a flange plane, lid plane, and/or transverse plane. A rim plane may be the same or offset from a flange plane. A lid plane may be a plane defined by a majority of the surface area of a lid (e.g., bottom or top surface of lid). A lid plane may be generally parallel or offset from a flange plane. A lid plane may be parallel to a transverse plane, a flange plane, or both. A frontal plane may be a plane intersecting through the container, the container base, the lid, or a combination thereof. A frontal plane may divide a container between a front and a rear. A frontal plane may define one or more planes of symmetry of one or more components of the container. A frontal plane may be located between a leading edge and a trailing edge of a lid. A frontal plane may have a vertical axis and/or frontal axis lying therein (e.g., parallel, not intersecting). A frontal plane may be generally perpendicular to a flange plane, lid plane, longitudinal plane, transverse plane, or a combination thereof. A longitudinal plane may be generally perpendicular to a transverse plane, frontal plane, flange plane, lid plane, or a combination thereof. A longitudinal plane may divide a container between sides (e.g., left and right). A longitudinal plane may have a longitudinal axis, vertical axis, and/or frontal axis lying therein and/or be parallel to. A longitudinal plane may have a centerline of the container lying therein (e.g., parallel to and lying in). A transverse plane may define an upper portion and a lower portion of a container. A transverse plane may be formed between a lid and a container base or may cut through the container base. A transverse plane may be perpendicular to a transverse plane, longitudinal plane, or both. A transverse plane may be parallel to a flange plane, lid plane, or both.

A container may or may not have a symmetrical shape. Symmetry may be symmetry about one or more planes. Symmetry may mean symmetry about a frontal plane, longitudinal plane, or any other symmetry plane such as any plane intersecting a center point of the container. A container having only one plane of symmetry may have one correct orientation for interaction with a feeding assembly, removal of a lid, or both. A container having two or more planes of symmetry may have two or more correct orientations for interaction with a feeding assembly, removal of a lid, or both. Interaction with a feeding assembly may include placement and/or orientation in and/or relative to a container storage subassembly, container handling subassembly, container opening subassembly, container holding subassembly, container disposal subassembly, waste collection subassembly, or a combination thereof. Interaction with a feeding assembly may include placement and/or orientation in and/or relative to a hopper, container magazine, jaws, hook, grabbing/retaining feature, cradle, lifting wedge, container display opening, disposal bar, waste receptacle, or a combination thereof. A single correct orientation may increase the accuracy of component interactions while reducing complexity and cost in container design, manufacturing, and/or shipping. Two or more correct orientations may reduce the probability of loading errors by a user. Loading errors may include incorrect orientation such that one or more features of a container intended to interact with one or more components of a feeding assembly are unable to perform their function and/or cooperate together.

### Feeding Assembly and Container

The feeding assembly may be any device that includes and dispenses food for consumption by an animal. Food may include any type of food suitable for consumption by an animal. Food may include wet food, dry food, or both. Wet food may include ground and/or shredded protein (e.g., meat), vegetables, grains, fruits, and/or the liked served in or mixed with a liquid. A liquid may refer to water, broth, gravy, or other liquid. Dry food may refer to food substantially free of liquid, may be in the form of granular material, or both.

The feeding assembly may be useful in presenting food in a container, removing food from a container, or both. The feeding assembly may be useful in retrieving or otherwise accessing a container of food stored therein and providing the contents of the container to be accessible by an animal. The animal may be any domestic animal. A domestic animal may include a dog, cat, pig, rabbit, hamster, guinea pig, ferret, the like, or any combination thereof. In a typical pet-owning household, the domestic animal may include one or more cats, dogs, or both.

The feeding assembly may include one or more of the following features: a housing, container storage subassembly, container handing subassembly, transport subassembly, container opening subassembly, container holding subassembly, disposal subassembly, waste collection subassembly, feeding area, the like, or a combination thereof.

The feeding assembly may include a housing. A housing may function to house and/or support various components of the feeding assembly, provide an aesthetically pleasing appearance to the feeding assembly, or both. A housing may include one or more bases, mid-supports, support plates, top covers, the like, or any combination thereof. A housing may provide for or define a feeding area.

A housing may provide for a feeding area. A feeding area may be a portion of a housing which presents a container and/or food to an animal such that it is accessible by the animal for consumption. A feeding area may be located at any level of the housing. A feeding area may be provided at the base, mid-support, support plate, top cover, or a combination thereof. A feeding area may be provided adjacent to (e.g., in front of) a base, mid-support, support plate, top cover, or any combination thereof. A feeding area may be defined by a container display opening.

The feeding assembly may include a container storage subassembly. A container storage assembly may function to have one or a plurality of containers temporarily disposed and stored therein. Disposed may mean stacked vertically, horizontal, radially, mounted to, the like, or any combination thereof. A container storage subassembly may provide for a single stack or a plurality of stacks of containers. A container storage assembly may provide for a single circular array of a plurality of containers or a plurality of circular arrays.

A container storage assembly may include one or more hoppers. One or more hoppers may be configured to store a plurality of containers therein. The containers may be stacked or otherwise aligned in a column. A hopper may receive the containers directly or receive a container magazine holding a plurality of containers. One or more hoppers may include 1 or more, 2 or more, or even 3 or more hoppers.

A container storage subassembly may include one or more restraint mechanisms. One or more restraint mechanisms may function to retain one or a plurality of containers within a hopper and/or container magazine; work against gravity; selectively release a container (e.g., when ready to be consumed); or any combination thereof. One or more restraint mechanisms may be located adjacent to, partially disposed in, in proximity to, and/or the like one or more hoppers. One or more restraint mechanisms may include one or more rollers, drive units, gears, pulleys, and/or the like.

A container storage assembly may include and/or be configured to removably receive a container magazine. A container magazine may function to store a plurality of containers together as a set, allow for multiple containers to be disposed into the container storage assembly in a single loading step, allow for a plurality of containers to be shipped together and then loaded into the container storage assembly together, provide for easy user access for loading containers, or any combination thereof. A container magazine may function as a cartridge to insert a plurality of containers into the feeding assembly.

The feeding assembly may include a container handling subassembly. A container handling subassembly may function to receive a container from a container store subassembly, retain a container during transport to a feeding area, retain a container in a feeding area, retain a container base during removal of a lid, transport a container for disposal after use, or any combination thereof. A container subassembly may be configured to releasably engage one or more containers. A container handling subassembly may be configured to be disposed in or adjacent to a feeding area. A container handling subassembly may be configured to actively retrieve (e.g., grasp) a container, have a container disposed therein, or both. A container handling subassembly may be configured to actively release a container, have a container disposed therefrom, or both. A container handling subassembly may include one or more shuttle assemblies, gripper assemblies, or both. A container handling subassembly may include one or more cradles, holding supports, bearings, through holes, disposal bars, arms, plates, bases, actuators, the like, or any combination thereof.

A container handling subassembly may be coupled to a transport subassembly. A container handling subassembly may be affixed to or part of a transport subassembly. A container handling subassembly may be moved between positions via a transport subassembly.

A container handling subassembly may be moveable to one or more positions within the feeding assembly. The container handling subassembly may be moveable to various positions to interact with one or more containers and/or other subassemblies. One or more positions may include a loading position, opening position, feeding position, disposing position, resting position, the like, or a combination thereof.

The feeding assembly includes a transport subassembly. A transport subassembly may function to cooperate with a container handling subassembly, move a container handling subassembly and/or container among varying positions withing a feeding assembly, or both. A transport subassembly may function to transport a container to a container opening subassembly, feeding area, and/or container disposal subassembly. A transport subassembly may function to move a container handling subassembly to a loading position, opening position, feeding position, disposing position, resting position, the like, or any combination thereof. A transport subassembly may function to move a container handling subassembly and/or container along one or more axes, one or more linear directions, or both. A transport subassembly may move a container handling subassembly along a single axis, along three dimensions, along two axes, and/or along three axes.

The feeding assembly may include a container opening subassembly. A container opening subassembly may function to open a container, to remove a lid, to separate a lid from a container base, to remove or at least partially open a casing, the like, or a combination thereof. A container opening subassembly may be referred to as lid removal subassembly or structure.

A container opening subassembly may be configured to releasably couple to the lid, apply a pulling force to a lid, and remove a lid from a container base. A container opening subassembly may engage with a lid, peel the lid from the container base as the lid and/or the container base is moved (e.g., via a transport subassembly, container handling subassembly, or both). A container opening subassembly may be configured to move the lid away from the container base while the container base is held static, retain the lid in place while the container base is moved, or move the lid away from the container base while the container base is also simultaneously moved away from the lid.

A container opening subassembly may include or include components which function as an arm, knife, hook, clamp, can opener, vacuum source, jaws, the like, or any combination thereof.

The feeding assembly may include a container holding subassembly. The container holding subassembly may function to retain a container in a feeding area, present a container in a feeding area, or both. The container holding subassembly may cooperate with one or more container handling subassemblies, transport subassemblies, portions of the housing, or any combination thereof to prevent movement of a container while in a feeding area, to facilitate presenting of a container in a feeding area, or both. A container holder subassembly may include or be a lifting wedge, arms, rails, shroud, or combination thereof.

The feeding assembly may include one or more container disposal subassemblies. A container disposal subassembly may urge a used container into a waste collection subassembly, cooperate with a container handling subassembly, cooperate with a transport subassembly, or any combination thereof. A container disposal subassembly may have a configuration which cooperates with a path of movement of a container handling subassembly. A container disposal subassembly may cause disposal of a container (e.g., used container base) from a container handling subassembly when moving away from a feeding position, at the disposing position, moving toward a resting position, moving toward a loading position, the like, or any combination thereof. A container disposal subassembly may be configured to move out of the way or otherwise not disturb a container in a container handling subassembly while moving toward a feeding position. A container disposal subassembly may be located along a path of movement of a container handling subassembly. A container disposal subassembly may be located on one or both sides of a channel. The one or more container disposal subassemblies may include two opposing disposal subassemblies on each side of a channel. A container disposal subassembly may be configured to retract away from a channel and/or travel path and avoid disturbing a container when a container handling subassembly is traveling toward a feeding position. A container disposal subassembly may be configured to extend into a channel and/or travel path to transfer a biasing force to a container handling subassembly to urge a container to be disposed. A container disposal subassembly may be located above, in proximity to, below, and/or adjacent to one or more waste collection subassemblies. A channel may be the channel in a mid-support, support plate, or both. A container disposal subassembly may include a mount, plunger, spring, ramped surface, levers, and/or the like.

The feeding assembly may include one or more waste collection subassemblies. A waste collection subassembly may be configured to collect one or more lids, container bases, food, and/or the like; collect one or more lids after removal from a container base; collect one or more container bases after an animal has been given the opportunity to consume therefrom; collect residual waste; the like; or any combination thereof. A waste collection subassembly may be easily accessible such that a user may be able to easily access waste contents within the waste collection subassembly for disposal. A waste collection subassembly may include one or more waste receptacles, openings, residual waste collectors, or both. A waste collection subassembly may include one or more waste receptacles, openings, removable lids, seals, trash bags, the like, or any combination thereof. A waste receptacle may be configured to receive lids, container bases, residual waste, or a combination thereof.

The feeding assembly may include one or more drive units. One or more drive units may be configured to drive movement of one or more components of the feeding assembly. The one or more drive sources may be associated with container storage assembly (e.g., restraint mechanism), a transport subassembly, a container opening subassembly, a container handling subassembly (e.g., grippers), a moveable cover (e.g., covering the container display opening), and/or the like. One or more drive sources may be shared amongst different components or be dedicated drive sources. For example, a drive source associated with the transport subassembly may also be associated with a container opening subassembly. A drive unit may also be referred to as an actuator.

The feeding assembly may include one or more sensing devices. One or more sensing devices may function to sense a presence of one or more containers, obtain one or more parameters of one or more containers and/or container magazines, sense a position of one or more subassemblies, or any combination thereof. One or more sensing devices may generally function to sense a status of one or more components within the feeding assembly. One or more sensing devices may be in electrical communication with one or more controllers. One or more sensing devices may include one or more identification sensors, container presence sensors, holder position sensors, weight sensors, the like, or any combination thereof.

One or more sensing devices may include one or more identification sensors. One or more identification sensors may function to read and/or communicate with one or more identifiers. One or more identification sensors may be disposed proximate to the container storage subassembly. One or more identification sensors may be disposed such as to have a view of, form a connection with, or both one or more identifiers of one or more containers. One or more identification sensors may function to obtain one or more parameters associated with the container and/or food therein, obtain access to a database or other repository having one or more parameters associated with the container and/or food therein, or both. One or more identification sensors may be any type of transceiver compatible with any identifier disclosed herein, able scan or read an identifier, able to obtain parameters associated with a container or food therein, able to direct a controller as to where to obtain parameters associated with a container or food therein, the like, or any combination thereof. The one or more identification sensors may include one or more radio frequency transmitters, barcode readers, QR code readers, nearfield communication transmitters (NFC), image sensors, the like, or any combination thereof. The identification sensor may be an optical sensor (e.g., a UV sensor, an IR sensor, a CCD camera, an electrical sensor, etc.). The one or more identification sensors may be compatible with one or more identifiers including a bar code, a QR code, a reflective feature, a scannable optical feature, an IR or UV visible printed feature, raised or recessed features, or an electrical circuit (e.g., a resistive electrical circuit), an NFC chip, an RFID, or any other visual, electric, or electromagnetic indicator.

The feeding assembly may be in communication with or include one or more power sources. A power source may function to provide power to one or more components of the device. A power source may be any typical power source for consumer products. A power source may be an outlet, direct current, alternating current, the like, or a combination thereof. The device may house an adapter for a power source, such as in base of the feeding assembly.

The feeding assembly may include one or more controllers. The one or more controllers may function to receive one or more signals, transmit one or more signals, control operations of one or more components of the device, or a combination thereof. The one or more controllers may be configured to control overall operation of the feeding assembly. The one or more controllers may be in communication with one or more sensing devices, subassemblies, communication modules, other components, or any combination thereof. The one or more controllers may be adapted to receive one or more signals from the one or more sensing devices, subassemblies, communication modules, and/or the like. The one or more controllers may be in electrical communication with one or more sensing devices, subassemblies, communication modules, and/or the like.

### Illustrative Examples

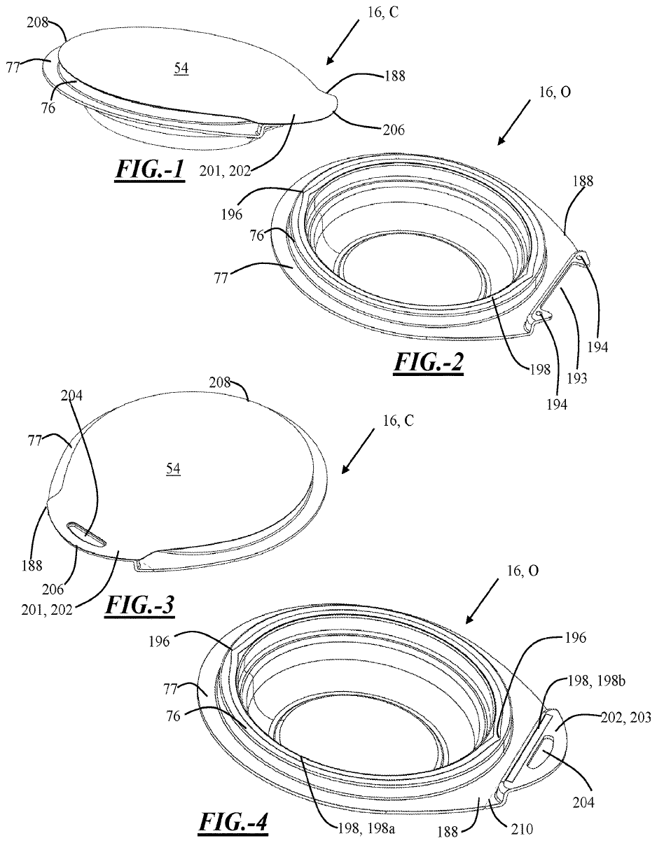

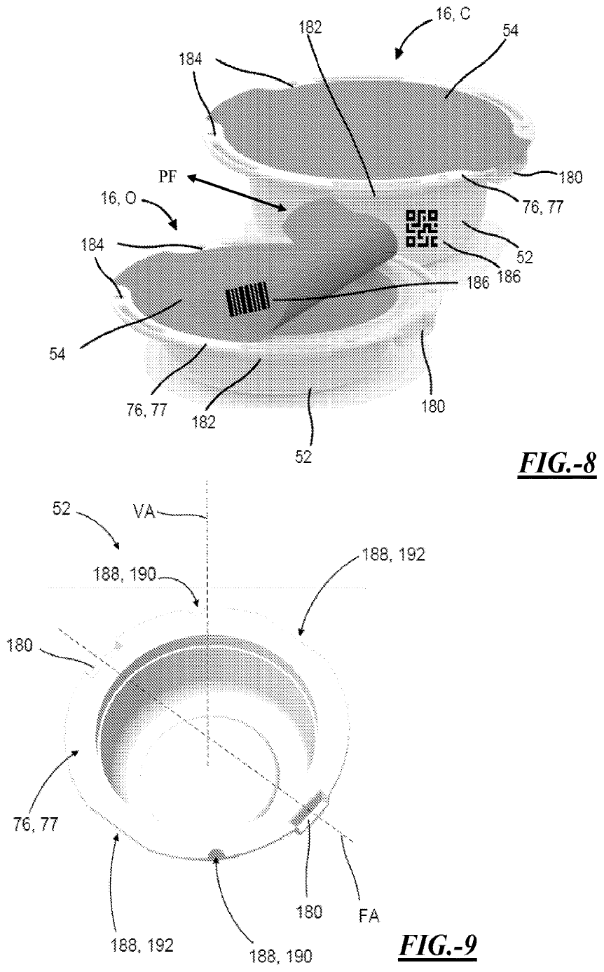

The following figures and explanations are intended as illustrative examples. Features of one example may be combined with features of another example. For example, the keying features of any of FIGS. 8-11 may be combined with any of the containers in FIGS. 1-7. For example, the lid reinforcing features and handling portion of the container in FIGS. 1-7 may be combined with any of the containers in FIGS. 8-11.

FIGS. 1-4 illustrate containers 16 in a closed configuration C and an open configuration O. In the closed configuration, a lid 54 covers a container base 52. In the open configuration O, a lid 54 is removed from the container base 52. The lid 54 and the container base 52 each include keying features 188. The keying features 188 may be defined as the overall peripheral shape (e.g., 2-dimensional plan shape and/or cross-section) of a flange 77 and the lid 54. The keying features 188, as exemplified, may be the overall tear-drop shape, ovular with a blunt end shape, circular with a lobe shape, and/or the like. The flange 77 may be separate from a rim 76. The lid 54 includes a handling portion 201. The lid 54 includes an extension tab 202. The extension tab 202 is the handling portion 201. The extension tab 202 may include a hook opening 204. The extension tab 202 may define the leading edge 206 of the lid. Opposite the leading edge 206 may be a trailing edge 208. The container base 52 may include a lid access feature 193 formed in a flange 77. Adjacent to the lid access feature 193 are tensioning features 194 (e.g., weld spots). The container base 52 may also include an extension tab 202. The extension tab 202 may also include a hook opening 204. The extension tab 202 may also be referred to as a lid reinforcing feature 203. The hook openings 204 may be aligned with one another. The container base 52 may include a scoring line 210. The scoring line 210 is located between the extension tab 202 and the remainder of the container base 52. The soring line 210 allows for the extension tab 202 to be broken away from the rest of the rim 76. The container base 52 includes a seal member 198. The seal member 198 includes stress rise features 196. The stress rise features 196 are located near where the leading edge 206 and trailing edge 208 of the lid 54 are adjoined to the container base 52. The seal member 198 includes a first seal member 198a and second seal member 198b. The first seal member 198a is located on the rim 76. The second seal member 198b is located at on the flange 77. The second seal member 198 is located at the lid reinforcing feature 203.

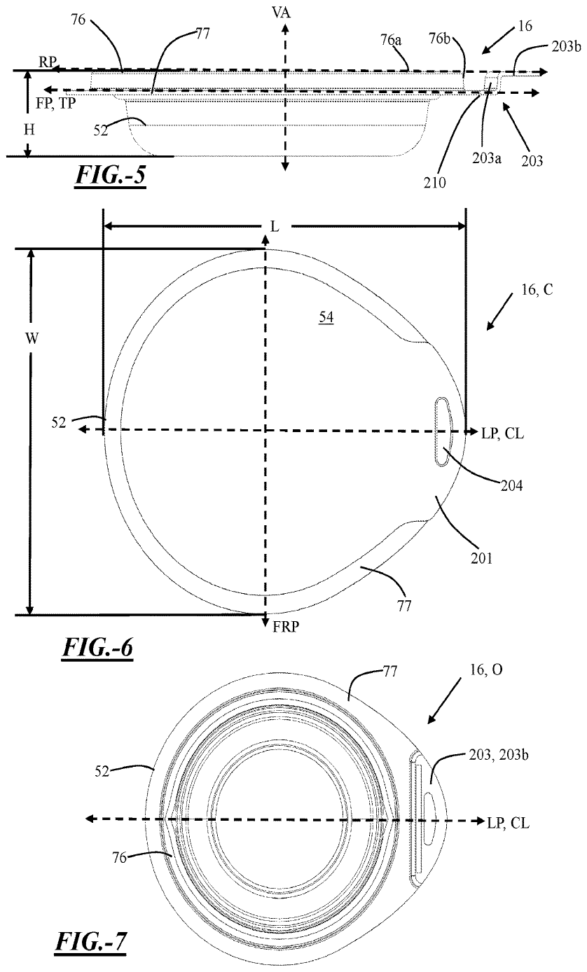

FIGS. 5-7 illustrate differing plan views of a container 16 in both an open O and closed configuration C. The container 16 includes a container base 52. The container 16 includes a container base 52 with a lid 54 removably affixed thereto.

The container 16 includes a vertical axis VA. The vertical axis VA extends through the container base 52 through the opening defined by the rim 76 and/or flanges 77 and/or the lid 54. A transverse plane TP lies substantially perpendicular to the vertical axis VA. The transverse plane is substantially parallel to a flange plane FP and or a rim plane RP. A flange plane FP is defined by an upper surface of the flange 77. A rim plane RP is defined by an upper surface of the rim 76. A longitudinal plane LP extends from the front to the rear of the container 16. A longitudinal plane LP may define a center line CL of the container 16. A frontal plane FRP extends from side to side of the container 16. The frontal plane FRP divides the container 16 from front and rear.

The container includes a height H, length L, and width W. The height H is measured parallel to a vertical axis VA. The height H is measured from a top to the bottom of the container 16. The length L is measured from front to rear. The length L is measured parallel to a longitudinal plane LP. The width W is measured side to side. The width W is measured parallel to a frontal plane FRP.

The lid 54 contains a handling portion 201. The handling portion 201 may include or be free of a hook opening 204. The handling portion 201 maybe located toward and or at the front of the container 16.

The handling portion 201 may be affixed to a lid reinforcing feature 203. A lid reinforcing feature 203 may include a vertically extending portion 203a and a lid contact portion 203b.

FIG. 8 illustrates a container 16 in a partially open configuration O and a container 16 in a closed configuration C. The container 16 in the closed configuration C also has a larger storage volume. The container 16 includes a container base 52 and a lid 54. The lid 54 is removable from the container base 52. The lid 54 may be removable via peeling force PF. The container base 52 includes a rim 76. The rim 76 is formed a flange 77. The container base 52 includes one or more pockets 180. The pockets 180 are formed as part of the rim 76. The container base 52 includes one or more alignment features 182. The alignment features 182 are formed as part of the rim 76. The container base 52 includes engagement features 184. The engagement features 182 are formed as part of the rim 76. The lid 54 of the container 16 in the open configuration O includes an identifier 186. The container base 52 of the container 16 in the closed configuration C includes an identifier 186.

FIG. 9 illustrates a container base 52. The container base 52 includes a vertical axis VA extending therethrough. The vertical axis VA is substantially centered to the container base. The container base 52 includes a rim 76. The rim 76 is formed as a flange 77. A flange axis FA is defined by the majority of the surface of the flange 77. The flange axis FA is substantially perpendicular to the vertical axis VA. The flange axis VA is aligned with opposing pockets 180. The flange 77 includes pockets 180 formed therein. The pockets 180 are formed as an indentation or change in surface of the flange 77. The pockets 180 project downward in a direction substantially similar to the vertical axis VA. The pockets 180 project away from the axis A. The flange 77 includes keying features 188 formed therein. The keying features 188 define a change in the peripheral contour of the flange 77. The keying features 188 include one or more indentations 190. The indentations 190 project inward toward the vertical axis VA. The keying features 188 include one or more straight edges 192. The straight edges 192 are substantially parallel to the axis A.

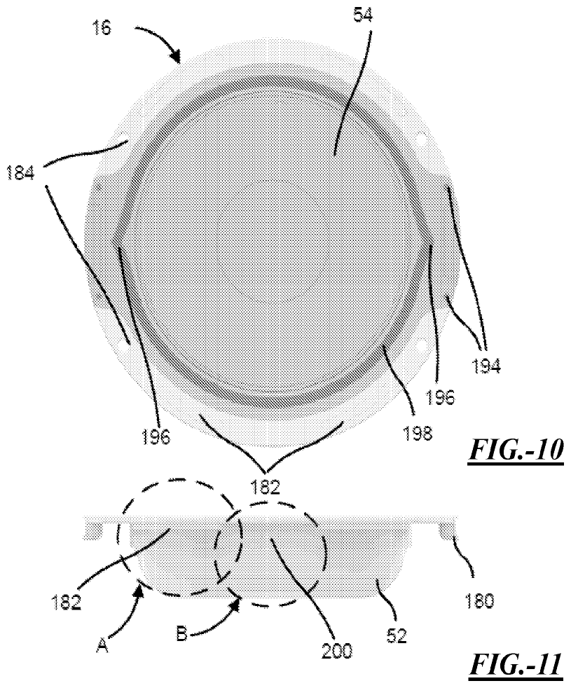

FIGS. 10 and 11 illustrate a container 16. The container 16 includes a container base 52. The container base 52 is closed via a lid 54. The lid 54 is removably adhered to the container base 52 via a seal member 198. The seal member 198 includes stress rise features 196. The container base 52 includes a flange 77. The flange 77 includes pockets 180 and alignment features 182. The container 16 includes tensioning features 194. The tensioning features 194 are provided as part of the lid 54. The container base 52 includes a planar surface 200.

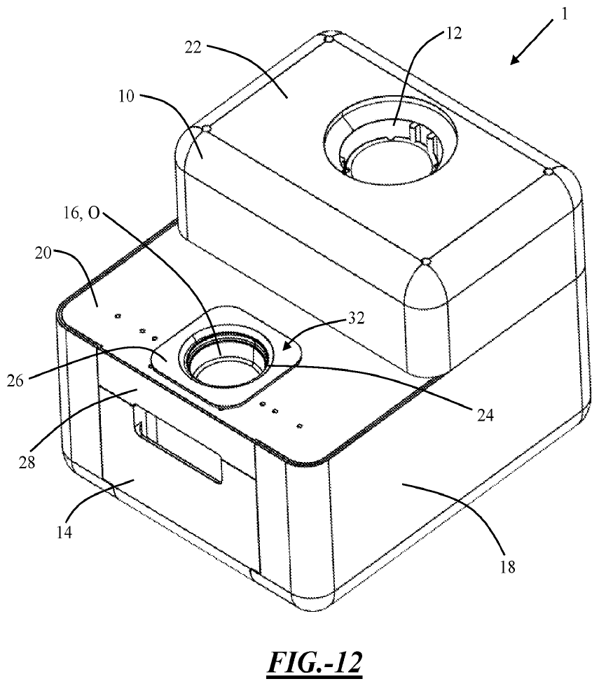

FIG. 12 is a perspective view of a feeding assembly 1. The feeding assembly 1 includes a housing 10, container storage subassembly 12, waste collection subassembly 14. The feeding assembly 1 presents a container 16 in an open configuration O. The housing 10 includes a base 18, mid-support 28, support plate 20, and top cover 22. The base 18 houses the waste collection subassembly 14. The support plate 20 includes a feeding area 32. The support plate 20 includes a container display opening 24. About the container display opening 24 and atop the support plate 20 is a guard 26.

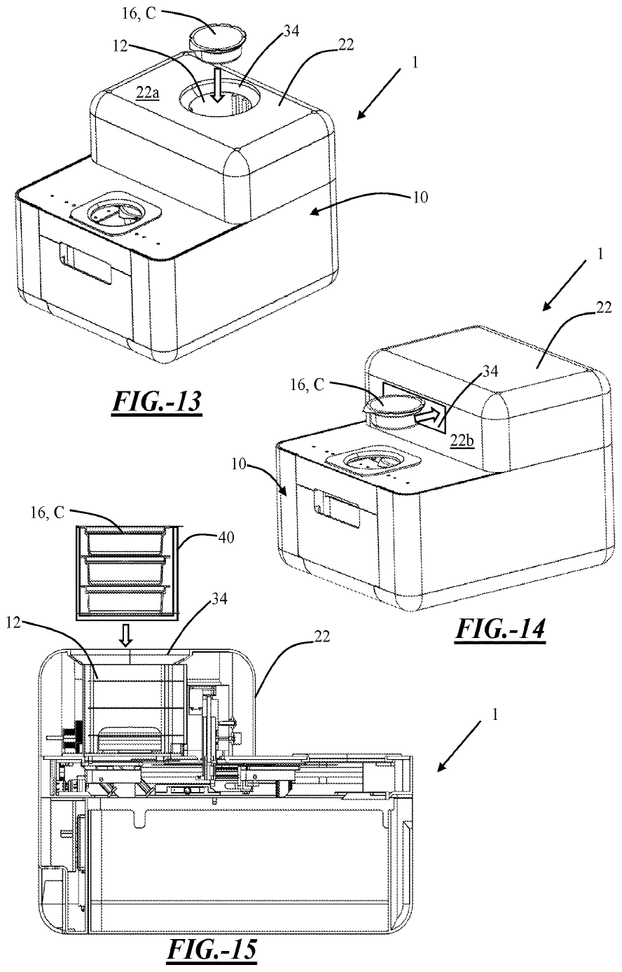

FIG. 13 illustrates a method of refilling a feeding assembly 1. The feeding assembly 1 is refilled with a container 16. The container 16 is in a closed configuration C. The container 16 is inserted into a container refill opening 34. The container refill opening 34 is formed in the housing 10. The container refill opening 34 is formed in a top cover 22. The container refill opening 34 is provided at a top surface 22a of the top cover 22. The container refill opening 34 provides access to a container storage subassembly 12.

FIG. 14 illustrates a method of refilling a feeding assembly 1. The feeding assembly 1 is refilled with a container 16. The container 16 is in a closed configuration C. The container 16 is inserted into a container refill opening 34. The container refill opening 34 is formed in the housing 10. The container refill opening 34 is formed in a top cover 22. The container refill opening 34 is provided at a side surface 22b of the top cover 22.

FIG. 15 illustrates a method of refilling a feeding assembly 1. The feeding assembly 1 is refilled with a plurality of containers 16. The plurality of containers 16 are each in a closed configuration C. The plurality of containers 16 are held together by a container magazine 40. The plurality of containers 16 are stacked together within the container magazine 40. The container magazine is inserted into a container refill opening 34. The container refill opening 34 is formed in a top cover 22. The container refill opening 34 provides access to a container storage subassembly 12.

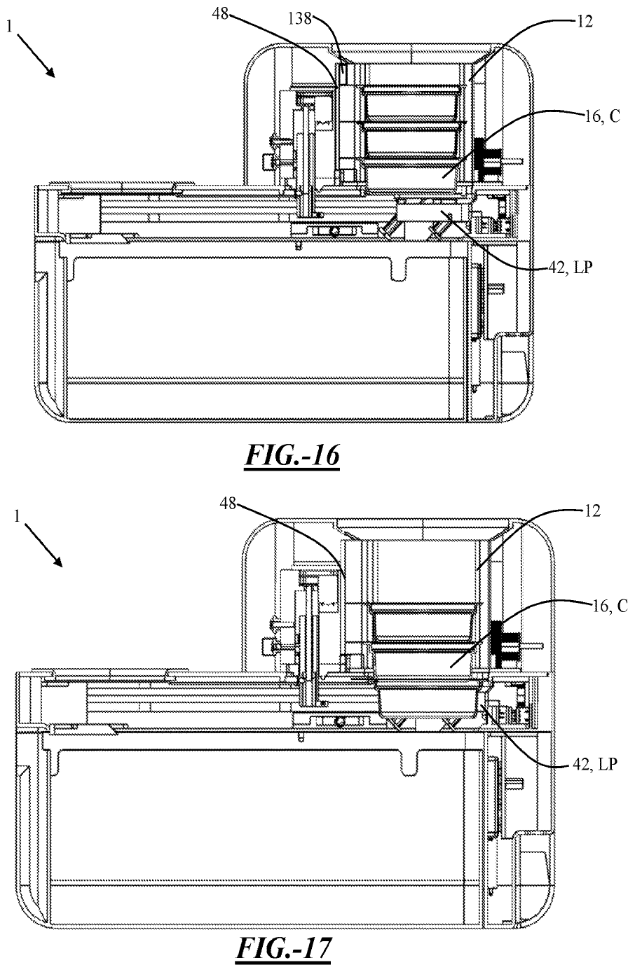

FIG. 16 is a cross-section view of a feeding assembly 1. The feeding assembly 1 includes a container storage subassembly 12. The container storage subassembly 12 is filled with a plurality of containers 16. The containers 16 are in a closed configuration C. The containers 16 are held in place within a hopper 48. In proximity to the hopper 48 is an identification sensor 138. The containers 16 are held in place by a restraint mechanism 50 (not shown). In proximity to the container storage subassembly 12 is a container handling subassembly 42. The container handling subassembly 42 is shown in a loading position LP. In the loading position LP, the container handling subassembly 42 may be aligned with the container storage subassembly 12. Alignment may allow for a container 16 to be transferred from the container storage subassembly 12 to the container handling subassembly 42.

FIG. 17 is a cross-section view of a feeding assembly 1. The feeding assembly 1 includes a container storage subassembly 12. The container storage subassembly 12 is filled with a plurality of containers 16. The containers 16 are in a closed configuration C. A container handling subassembly 42 is adjacent to the container storage subassembly 12 and in the loading position LP. The container handling subassembly 42 is aligned with a hopper 48. A restraint mechanism 50 (not shown) urges a container 16 into the container handling subassembly 42.

FIG. 18 is a cross-section view of a feeding assembly 1. A container handling subassembly 42 moves from a loading position LP to an opening position OP. The container handling subassembly 42 moves from the container storage subassembly 12 toward a feeding area 32. The container handling subassembly 42 moves a container 16 which is in a closed configuration from the container storage subassembly 12 toward a container opening subassembly 46. The container opening subassembly 46 engages with a lid 54. In this example, the container opening subassembly 46 pinches the lid 54. As the container handling subassembly 42 continues to move toward the feeding area 32, the container opening subassembly 46 continues to retain a portion of the lid 54. By maintaining a portion of the lid 54 as static while a container base 52 continues to move to a feeding area 32, the lid 54 is removed from the container base 52.

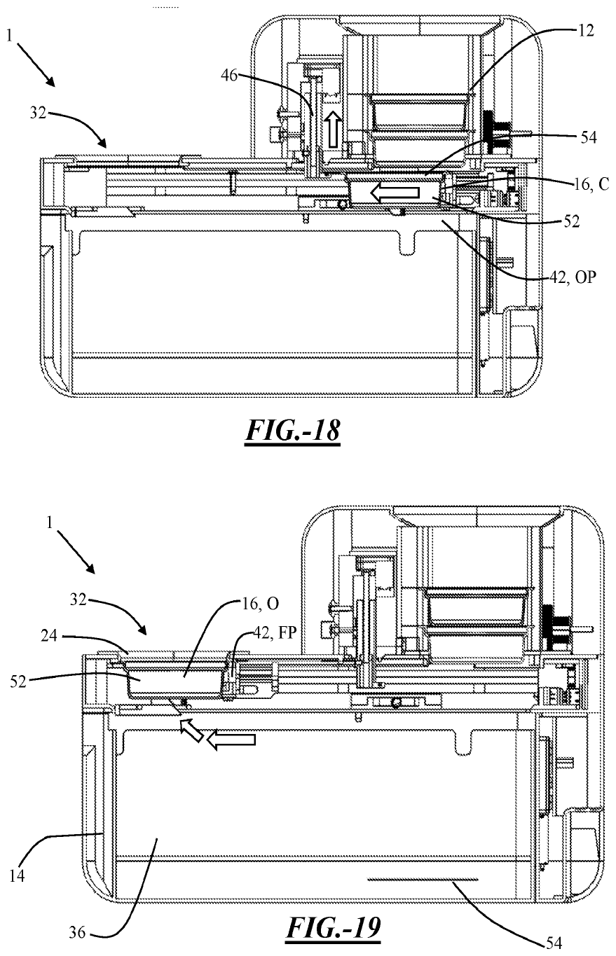

FIG. 19 is a cross-section of a feeding assembly 1. A container handling subassembly 42 is located within, below, and/or adjacent to a feeding area 32. The container handling subassembly 42 is in a feeding position FP. The container handling subassembly 42 includes a container 16 therein. The container 16 is in an open configuration O. The lid 54 has been previously removed. The lid 54 is located within a waste collection subassembly 14. The lid 54 is within a waste receptacle 36 of the waste collection subassembly 14. The container handling subassembly 42 moves both horizontally and vertically up into the feeding area 32. The upward motion results in the container 16 being moved up into a container display opening 24.

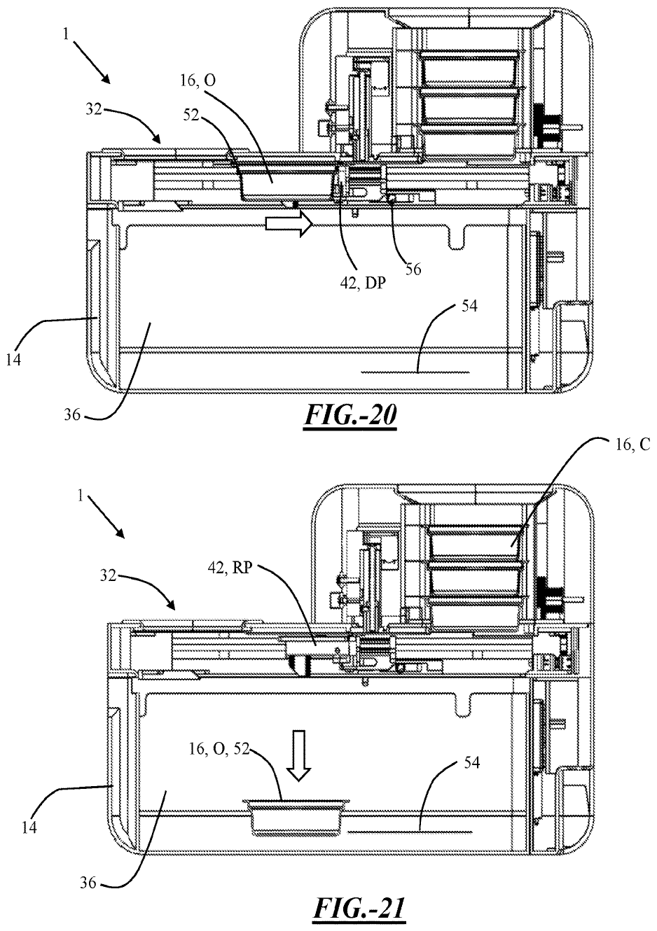

FIGS. 20 and 21 are a cross-section of a feeding assembly 1. A container handling subassembly 42 is moved toward a trash subassembly 56. The trash subassembly 56 cooperates with the container handling subassembly 42. The container handling subassembly is in a disposing position DP. Interaction between the trash subassembly 56 and the container handling subassembly 42 urges a container 16 into a waste collection subassembly 14. The container 16 falls into a waste receptacle 36. After the container 16 is disposed into the waste collection subassembly 14, the container handling subassembly 42 rests in a resting position RP. The container handling subassembly 42 may wait in this position until a subsequent container 16 from the container storage subassembly 12 is ready to be dispensed and presented to an animal for consumption.

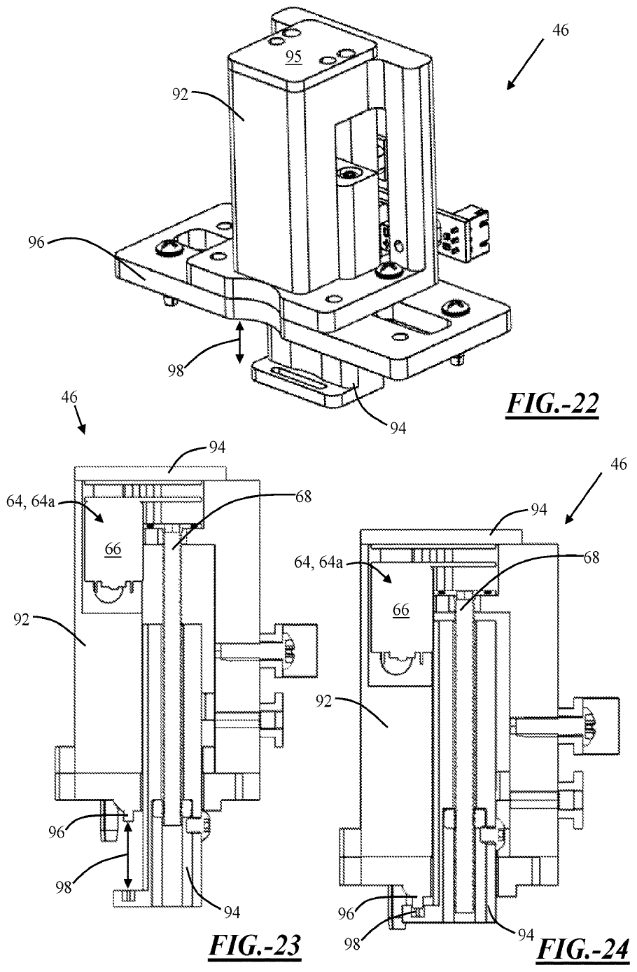

FIGS. 22, 23, and 24 illustrate a container opening subassembly 46. The container opening subassembly 46 includes a drive unit 64. The drive unit 64 includes a motor 66 and a drive shaft 68. The drive unit 64 may be configured as a thread motor 64a. The drive unit 64 may be housed and supported by a drive support 92. The drive unit 64 may be mounted to a drive unit cap 95. Rotatably engaged with the drive shaft 68 is a moveable jaw 94. The moveable jaw 94 is static relative to a static jaw 96. As the drive shaft 68 rotates, the moveable jaw 94 may move closer or further from the static jaw 96. Movement of the moveable jaw 94 can cause a pinch gap 98 to become larger or smaller. A lid 54 (not shown) may be moved into the pinch gap 98. The lid 54 (not shown) may be pinched and retained between the moveable jaw 94 and the static jaw 96.

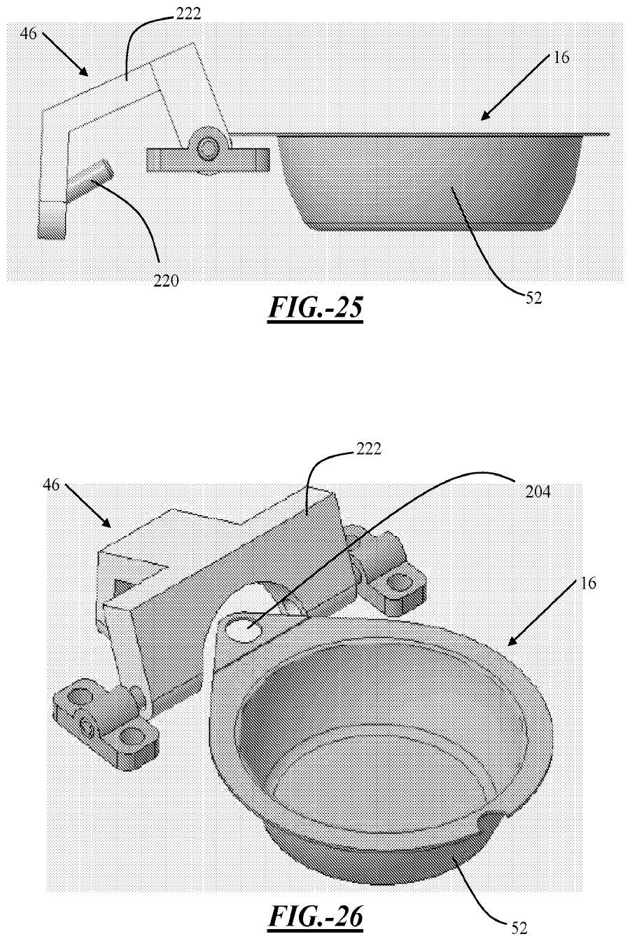

FIGS. 25 and 26 illustrate a container opening subassembly 46. The container opening subassembly assembly 46 includes a hook 220. The hook 220 is affixed to an arm 222. The arm 222 may be moveable (e.g., rotatable) or static. The arm may be drivable by a drive unit. The arm may be drivable by a force applied by the container. The hook 220 interacts with a hook opening 204 of a container 16. The hook opening 204 may be formed in the container base 52 and/or the lid 54 (not shown).

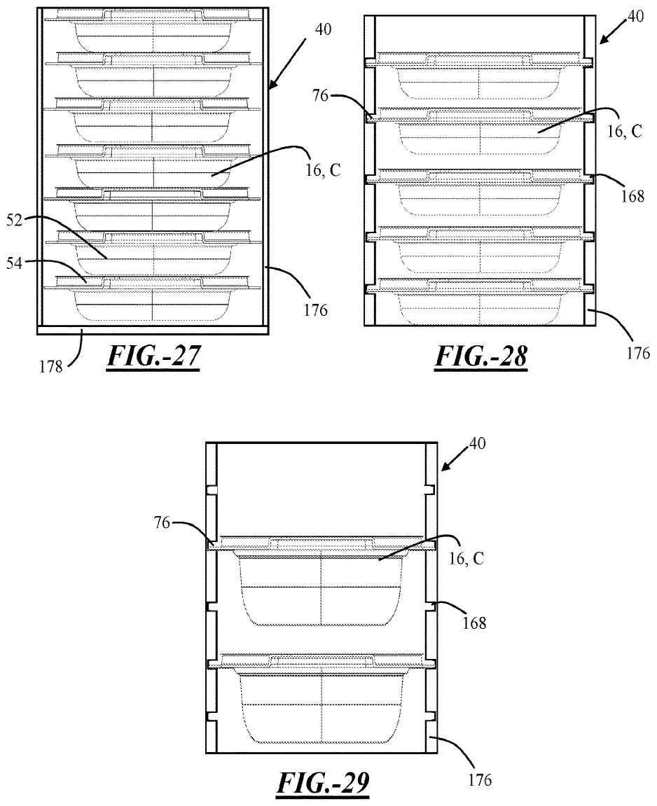

FIGS. 27, 28, and 29 illustrate a container magazine 40. The container magazine 40 is configured to hold a plurality of containers 16 in a closed configuration C. The containers 16 are vertically stacked.

In FIG. 27, the containers 16 are stacked one on top of the other. A lid 54 of container 16 supports a container base 52 of an adjacent container 16. The container magazine 40 includes an outer wall 176. The outer wall 176 defines the hollow interior of the magazine 40. The container magazine 40 includes a cover 178. The cover 178 may be removable to allow for the containers 16 to be dispensed.

In FIGS. 28 and 29, the containers 16 are supported by the container magazine 40. The container magazine 40 includes a plurality of slots 168. The slots 168 are formed in an outer wall 176. The slots 168 support a rim or flange 76 of the containers 16. The slots 168 may be spaced apart to adapt to different volume containers 16. For example, containers 16 with a larger volume may use only some of the slots 168 while containers 16 of smaller volume use all or different slots. FIGS. 28 and 28 illustrate the compatibility with different volume containers 16.

Unless otherwise stated, any numerical values recited herein include all values from the lower value to the upper value in increments of one unit provided that there is a separation of at least 2 units between any lower value and any higher value. As an example, if it is stated that the amount of a component, a property, or a value of a process variable such as, for example, temperature, pressure, time and the like is, for example, from 1 to 90, preferably from 20 to 80, more preferably from 30 to 70, it is intended that intermediate range values such as (for example, 15 to 85, 22 to 68, 43 to 51, 30 to 32 etc.) are within the teachings of this specification. Likewise, individual intermediate values are also within the present teachings. For values which are less than one, one unit is considered to be 0.0001, 0.001, 0.01 or 0.1 as appropriate. These are only examples of what is specifically intended and all possible combinations of numerical values between the lowest value and the highest value enumerated are to be considered to be expressly stated in this application in a similar manner.

Unless otherwise stated, all ranges include both endpoints and all numbers between the endpoints. The use of “about” or “approximately” in connection with a range applies to both ends of the range. Thus, “about 20 to 30” is intended to cover “about 20 to about 30”, inclusive of at least the specified endpoints.

The terms “generally” or “substantially” to describe angular measurements may mean about +/31 10°or less, about +/−5°or less, or even about +/−1° or less. The terms “generally” or “substantially” to describe angular measurements may mean about +/−0.01° or greater, about +/−0.1° or greater, or even about +/−0.5°or greater. The terms “generally” or “substantially” to describe linear measurements, percentages, or ratios may mean about +/−10% or less, about +/−5% or less, or even about +/−1% or less. The terms “generally” or “substantially” to describe linear measurements, percentages, or ratios may mean about +/−0.01% or greater, about +/−0.1% or greater, or even about +/−0.5% or greater.

The disclosures of all articles and references, including patent applications and publications, are incorporated by reference for all purposes. The term “consisting essentially of” to describe a combination shall include the elements, ingredients, components or steps identified, and such other elements ingredients, components or steps that do not materially affect the basic and novel characteristics of the combination. The use of the terms “comprising” or “including” to describe combinations of elements, ingredients, components or steps herein also contemplates embodiments that consist essentially of, or even consist of the elements, ingredients, components or steps. Plural elements, ingredients, components or steps can be provided by a single integrated element, ingredient, component or step. Alternatively, a single integrated element, ingredient, component or step might be divided into separate plural elements, ingredients, components or steps. The disclosure of “a” or “one” to describe an element, ingredient, component or step is not intended to foreclose additional elements, ingredients, components or steps.

It is understood that the above description is intended to be illustrative and not restrictive. Many embodiments as well as many applications besides the examples provided will be apparent to those of skill in the art upon reading the above description. The scope of the invention should, therefore, be determined not with reference to the above description, but should instead be determined with reference to the appended claims, along with the full scope of equivalents to which such claims are entitled. The disclosures of all articles and references, including patent applications and publications, are incorporated by reference for all purposes. The omission in the following claims of any aspect of subject matter that is disclosed herein is not a disclaimer of such subject matter, nor should it be regarded that the inventors did not consider such subject matter to be part of the disclosed inventive subject matter.

What is claimed is:

1. (canceled)

2. A container suitable for storing a food for an animal therein, the container comprising:
a) a container base defining a food cavity configured to retain food therein, wherein the container base includes:
i) a storage portion having a bottom wall and one or more side cavity;
ii) one or more flanges; and
iii) one or more lid access features formed as one or more indentations in the one or more flanges;
b) a lid removably affixed to the container base, wherein the lid includes a handling portion which includes a bottom surface of the lid which is exposed from the one or more flanges at the one or more indentations such that a leading edge is accessible, wherein the leading edge is an edge of the lid which is configured to be peeled or otherwise removed from the container first and wherein a trailing edge is an edge of the lid which is peeled last; and
c) one or more seal members which removably affix the lid to the container base, wherein the one or more seal members include two or more stress rise features which area portion of the one or more seal members formed as a tapered point wherein at lest stress rise feature is located adjacent to and/or at the leading edge and at lest another stress feature is located to and/or at the trailing edge.

3-7. (canceled)

8. The container of claim 2, wherein the two or more stress rise features allow for a less pulling force to initiate peeling of the lid off the container base and/or finalize peeling of the lid than without the presence of the two or more stress rise features.

9. (canceled)

10. The container of claim 2, wherein the two or more stress rise features are one or more vertices of the one or more seal members at opposing axial ends of the one or more seal members.

11-12. (canceled)

13. The container of claim 10, wherein the one or more seal members has a cross-sectional or plan shape which is substantially lemon-shaped, diamond-shaped, or both.

14. The container of claim 10, wherein the one or more seal members is an adhesive separate from the lid and the container base, a formed joint between the lid and the container base, or both.

15-16. (canceled)

17. The container of claim 2, wherein the one or more side walls taper away from the bottom wall such that a width of the food cavity toward the bottom wall is narrower than a width of the food cavity toward a rim.

18. The container of claim 17, wherein the one or more side walls are angled related to the bottom wall such that they form an angle which is obtuse relative to the bottom wall; and wherein the angle is about 95 degrees or greater to about 120 degrees or less.

19-20. (canceled)

21. The container of claim 17, wherein a height of the container base is determined as a distance from the bottom wall to the rim of the one or more side walls, the lid, or both; and
wherein the height of the container base is about 2 cm or greater to about 7 cm or less.

22-23. (canceled)

24. The container of a claim 17, wherein there is a radius of curvature where the one or more side walls join the bottom wall; and
wherein the radius of curvature is about 5 mm or greater to about 15 mm or less.

25-28. (canceled)

29. The container of a claim 2, wherein the one or more side walls of the container base have a cross-section or a plan shape which is substantially reciprocal with that of the bottom wall of the container base.

30-32. (canceled)

33. The container of claim 2, wherein the one or more flanges are about the one or more side walls and project substantially laterally away from the one or more side walls.

34-39. (canceled)

40. The container of claim 2, wherein the one or more flanges have a cross-sectional or a plan shape dissimilar to that of the one or more seal members, the bottom wall; and the one or more side walls.

41. (canceled)

42. The container of claim 2, wherein the one or more flanges include one or more lid reinforcing features:
wherein the one or more lid reinforcing features include a portion of the one or more flanges adhered to the lid; and
wherein the one or more lid reinforcing features are a portion of the one or more flanges which provide for an extension which projects away from the storage portion further than a remainder of the one or more flanges.

43-53. (canceled)

54. The container of wherein the container base is comprised of one or more food grade materials.

55. The container of claim 54, wherein the container base is comprised of polyethylene terephthalate (PET), high-density polyethylene (HDPE), low-density polyethylene (LDPE), polyvinyl chloride (PVC), polypropylene (PP), polystyrene (PS), polycarbonate, ethylene vinyl alcohol (EVOH), or a combination thereof.

56. (canceled)

57. The container of claim 2, wherein the lid does not extend beyond a majority of the one or more flanges of the container.

58. The container of claim 57, wherein the lid has a cross-sectional or plan shape dissimilar to that of the one or more seal members, the bottom wall, and the one or more side walls.

59-61. (canceled)

62. The container of claim 57, wherein the lid has a rounded shaped which comes to a blunt surface at the leading edge of the lid.

63. The container of claim 2, wherein the container is symmetrical only about one plane of symmetry.

64. The container of claim 63, wherein the container is symmetrical about a longitudinal plane which extends through the leading edge of the lid to the trailing edge of the lid and intersects both the lid and the container base.

65. (canceled)

66. The container of claim 2, wherein the container includes one or more keying features.
wherein the one or more keying features are configured to aid in correct placement of the container within a feeding assembly, container magazine, or both;
wherein the one or more keying features are associated with a unique geometry of an exterior of the container; and
wherein the one or more keying features are one or more portions of the container base.

67-69. (canceled)

70. The container of claim 66, wherein the one or more keying features include one or more concave portions, convex portions, protrusions, indentations, flat surface, straight edges, or any combination thereof, and
wherein the one or more keying features refer to an overall shape of the one or more flanges, a two dimensional shape of the one or more flanges, or both.

71-85. (canceled)

86. The container claim 2, wherein the container includes one or more identifiers which are configured to identify one or more parameters related to the container, the food, or both;
wherein the identifier includes one or more visual identifiers, signal identifiers, or both;
wherein the one or more visual identifiers include one or more quick response (“OR”) codes, bar codes, colored patterns text: surface reflectivity patterns, or a combination thereof and
wherein the one or more signal identifiers include one or more radio frequency identification tags (“RFID”), near-field communication (“NFC”) tags, or a combination thereof.

87-89. (canceled)

90. The container of as claim 86, wherein the one or more identifiers are located on and/or in the lid, the container base, or both ;.

91-92. (canceled)
